SEQUENCE LISTING (3 sequences)

SEQ ID NO: 1 - DNA, 32 bp, Artificial
  hypothetical sequence for an illustration
actatgacgctttccatccgggctagctctca

SEQ ID NO: 2 - RNA, 21 nt, Artificial
  hypothetical RNA for illustration
acuaugacgcuuuccaucggg

SEQ ID NO: 3 - protein, 6 aa, Artificial
  hypothetical protein sequence for illustration
YDAFHR

(19) United States
(12) Patent Application Publication
(10) Pub. No.: US 2007/0174008 A1
(43) Pub. Date: Jul. 26, 2007

(54) Method and system for determining a zero point for array-based comparative genomic hybridization data

(76) Inventors: Zohar Yakhini, Ramat Hasharon (IL); Doron Lipson, Rehovot (IL); Amir Ben-Dor, Bellevue, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/338,515

(22) Filed: Jan. 24, 2006

(51) Int. Cl. G06F 19/00

(52) U.S. Cl. 702/19

(57) ABSTRACT

Various embodiments of the present invention determine a zero point, or centralization constant ζ, for an array-based comparative genomic hybridization (“aCGH”) data set by identifying a zero-point value, or centralization constant ζ, that, when used in an aberration-calling analysis of the aCGH data, results in the fewest number of array-probe-complementary genomic sequences identified as having abnormal copy numbers with respect to a control genome, or, in other words, results in the greatest number of array-probe-complementary genomic sequences identified as having normal copy numbers. In one embodiment, interval-based analysis of an aCGH data set may be carried out using a range of putative zero-point values, and the zero-point value for which the maximum number of genomic sequences are determined to have normal copy numbers may then be selected.

### TECHNICAL FIELD OF THE INVENTION

The present invention is related to analysis of array-based comparative genomic hybridization data, and, in particular, to various method and system embodiments for determining a zero point, or centralization constant, for array-based comparative genomic hybridization data set.

### BACKGROUND OF THE INVENTION

A great deal of basic research has been carried out to elucidate the causes and cellular mechanisms responsible for transformation of normal cells to precancerous and cancerous states and for the growth of, and metastasis of, cancerous tissues. Enormous strides have been made in understanding various causes and cellular mechanisms of cancer, and this detailed understanding is currently providing new and useful approaches for preventing, detecting, and treating cancer.

There are myriad different types of causative events and agents associated with the development of cancer, and there are many different types of cancer and many different patterns of cancer development for each of the many different types of cancer. Although initial hopes and strategies for treating cancer were predicated on finding one or a few basic, underlying causes and mechanisms for cancer, researchers have, over time, recognized that what they initially described generally as “cancer” appears to, in fact, be a very large number of different diseases. Nonetheless, there do appear to be certain common cellular phenomena associated with the various diseases described by the term “cancer.” One common phenomenon, evident in many different types of cancer, is the onset of genetic instability in precancerous tissues, and progressive genomic instability as cancerous tissues develop. While there are many different types and manifestations of genomic instability, a change in the number of copies of particular DNA subsequences within chromosomes and changes in the number of copies of entire chromosomes within a cancerous cell may be a fundamental indication of genomic instability. Although cancer is one important pathology correlated with genomic instability, changes in gene copies within individuals, or relative changes in gene copies between related individuals, may also be causally related to, correlated with, or indicative of other types of pathologies and conditions, for which techniques to detect gene-copy changes may serve as useful diagnostic, treatment development, and treatment monitoring aids.

Various techniques have been developed to detect and at least partially quantify amplification and deletion of chromosomal DNA subsequences in cancerous cells. One technique is referred to as “comparative genomic hybridization.” Comparative genomic hybridization (“CGH”) can offer striking, visual indications of chromosomal-DNA-subsequence amplification and deletion, in certain cases, but, like many biological and biochemical analysis techniques, is subject to significant noise and sample variation, leading to problems in quantitative analysis of CGH data. Array-based comparative genomic hybridization (“aCGH”) has been relatively recently developed to provide a higher resolution, highly quantitative comparative-genomic-hybridization technique. The increased accuracy and resolution of array-based comparative genomic hybridization has led to new data analysis problems, including the problem of properly normalizing observed array-based-comparative-genomic-hybridization data in order to accurately determine amplified and deleted regions of genomes with high reliability and resolution. Researchers and developers of aCGH techniques and equipment have recognized the need for reliable normalization techniques for aCGH data.

### SUMMARY OF THE INVENTION

Various embodiments of the present invention determine a zero point, or centralization constant ζ, for an array-based comparative genomic hybridization (“aCGH”) data set by identifying a zero-point value, or centralization constant ζ, that, when used in an aberration-calling analysis of the aCGH data, results in the fewest number of array-probe-complementary genomic DNA subsequences identified as being present at abnormal copy levels. Abnormal copy levels may occur as a result of deletion and amplification of various genomic subsequences with respect to a control genome. In other words, a zero-point value, or centralization constant ζ, is selected for aCGH analysis that results in the greatest number of array-probe-complementary genomic DNA sequences identified as being present at the normal, control-genome copy number.

In one method embodiment of the present invention, aberration-calling analysis of an aCGH data set is carried out using a range of putative zero-point values, and the zero-point value is selected for which the largest number of genomic sequences are determined to be present in the sample genome at the same copy number as in the control genome. In an alternative method embodiment of the present invention, an iterative, heuristic approach is used to converge on a zero-point value. The first iteration of the alternative method employs an initial interval-based analysis of an aCGH data set with an initial zero-point value, and each subsequent iteration determines a new, proposed zero-point value by maximizing the number of intervals that would be considered to be present in the sample genome at the same copy number as in the control genome with respect to the new, proposed zero-point value. Method embodiments of the present invention can be incorporated in a variety of array instrumentation, array-data analysis systems, and other devices and data analysis and processing systems.

### BRIEF DESCRIPTION OF THE DRAWINGS

FIG. 1 shows the chemical structure of a small, four-subunit, single-chain oligonucleotide.

FIG. 2 shows a symbolic representation of a short stretch of double-stranded DNA.

FIG. 3 illustrates construction of a protein based on the information encoded in a gene.

FIG. 4 shows a hypothetical set of chromosomes for a very simple, hypothetical organism.

FIG. 5 shows examples of gene deletion and gene amplification in the context of the hypothetical genome shown in FIG. 4.

FIGS. 6-7 illustrate detection of gene amplification by CGH.

FIGS. 8-9 illustrate detection of gene deletion by CGH.

FIGS. 10-12 illustrate microarray-based CGH.

FIG. 13 illustrates one method for identifying and ranking intervals and removing redundancies from lists of intervals identified as probable deletions or amplifications.

FIGS. 14A-C illustrate hypothetical red/green data for three hypothetical chromosomes that used in the following discussion to illustrate problems addressed by methods and systems of the present invention.

FIGS. 15A-19C show plots of the amplified and deleted regions of the three hypothetical chromosomes shown in FIGS. 14A-C determined by an aberration-calling method using a range of candidate centralization constants or zero points.

FIGS. 17A-C show plots of regions of amplification and deletion in the three hypothetical chromosomes determined by using a zero-point value, or candidate centralization constant ζ, of −0.2.

FIGS. 17A-C show amplification/deletion plots generated by the routine “step-gram function” using a zero-point value, or candidate centralization constant ζ, of 0.0.

FIGS. 18A-18C show amplification/deletion plots generated by using a zero-point value, or candidate centralization constant ζ, of 0.2.

FIGS. 19A-19C show amplification/deletion plots generated by using a zero-point value, or candidate centralization constant ζ, of 0.4.

FIG. 20 shows a plot of the number of normal-copy-number chromosome subsequences determined by using ζ values in a range from −4.0 through 4.0, with 0.2 increments.

FIGS. 21A-C show red/green data for the hypothetical three chromosomes, as shown in FIGS. 14A-C, with the red signal increased approximately by a factor of three with respect to the red signal in the hypothetical examples shown in FIGS. 14A-C.

FIGS. 22A-C show amplification/deletion plots generated by the using a zero-point value, or candidate centralization constant ζ, of 0.0.

FIG. 23 shows a plot of the number of normal-copy-number chromosome subsequences versus the zero-point value used in an aberration-calling analysis, similar to the plot shown in FIG. 20.

FIGS. 24A-C show amplification/deletion plots generated by using a zero-point value, or centralization constant ζ, of 1.2, as suggested by the plot shown in FIG. 23.

FIG. 25 illustrates, as a control-flow diagram, one method embodiment of the present invention.

FIGS. 26A-B illustrate, as two control-flow diagrams, an alternative routine “center” representing a second method embodiment of the present invention for finding the zero-point value, or centralization constant ζ, for an aCGH data set.

FIGS. 27A-C illustrate improvement in the determination of amplified and deleted regions using a zero-point value determined by method embodiments of the present invention.

FIG. 28 illustrates the same portion of the human chromosome 8 shown in FIGS. 27A-C, with the log ratio data plotted over the indications of deleted and amplified regions computed using a zero-point value of 0.0.

FIGS. 29A-B show a plot of the number of abnormal-copy-number chromosome subsequences versus zero-point values used in successive interval-based aCGH analyses, along with a plot of the log-ratio data, over which a line indicating the best zero-point value is superimposed, for a normal tissue vs. a normal control.

FIGS. 30A-B show a plot of the number of abnormal-copy-number chromosome subsequences versus zero-point values used in successive interval-based aCGH analyses, along with a plot of the log ratio data over which a line indicating the indicated zero-point value is superimposed, for a pathological tissue vs. a normal control.

FIGS. 31A-B show additional plots of the number of abnormal-copy-number chromosome subsequences versus zero-point values used in interval-based aCGH analysis, along with a plot of the log ratio data over which a line indicating the indicated zero-point value is superimposed, for additional pathological tissues vs. normal controls, using the same illustration conventions as used in FIGS. 30A-B.

FIGS. 32A-B show further examples of computed zero-point values from aCGH data sets extracted from normal and pathological tissues.

FIGS. 33A-B show a user-interface display that represents one embodiment of the present invention.

### DETAILED DESCRIPTION OF THE INVENTION

Embodiments of the present invention are directed to methods and systems for identifying zero-point values, or centralization constants, for aCGH data sets. Commonly, aCGH data sets are analyzed using aberration-calling methods in order to determine those array-probe-complementary chromosome subsequences that have abnormal copy numbers with respect to a control genome. Abnormal copy numbers may include amplification of chromosome subsequences and deletion of chromosome subsequences with respect to a normal genome, or to increased or decreased copies of entire chromosomes. In a first subsection, below, a discussion of array-based comparative genomic hybridization methods and interval-based aberration-calling methods for analyzing aCGH data sets is provided. In a second subsection, embodiments of the present invention are discussed.

### Array-Based Comparative Genomic Hybridization and Interval-Based aCGH Data Analysis

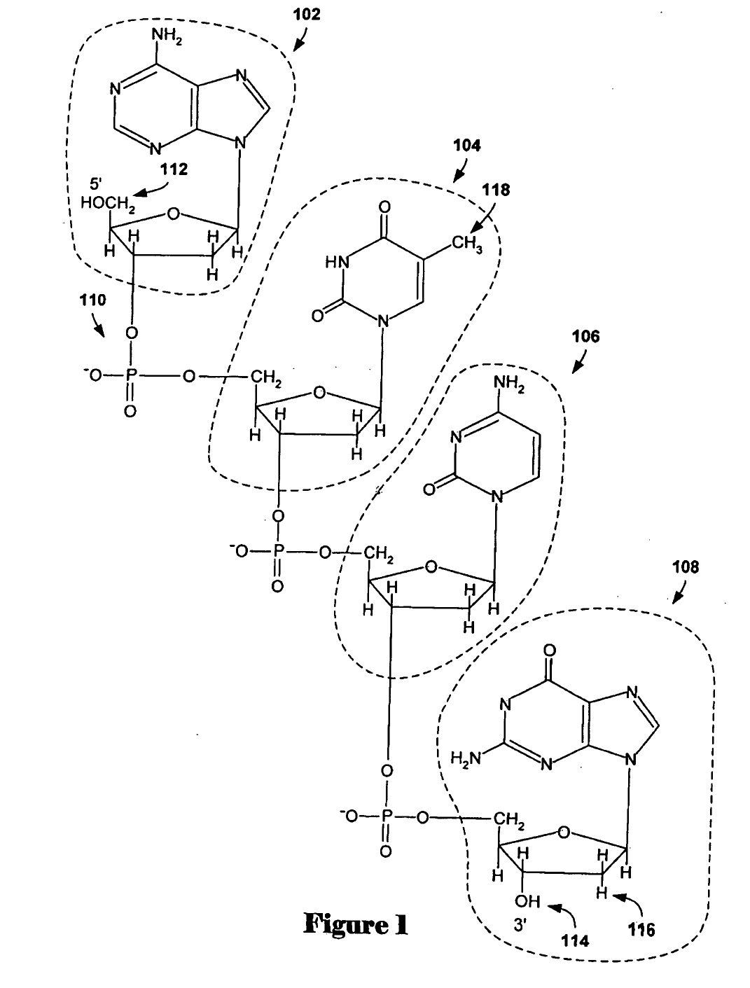

Prominent information-containing biopolymers include deoxyribonucleic acid (“DNA”), ribonucleic acid (“RNA”), including messenger RNA (“mRNA”), and proteins. FIG. 1 shows the chemical structure of a small, four-subunit, single-chain oligonucleotide, or short DNA polymer. The oligonucleotide shown in FIG. 1 includes four subunits: (1) deoxyadenosine 102, abbreviated “A”; (2) deoxythymidine 104, abbreviated “T”; (3) deoxycytodine 106, abbreviated “C”; and (4) deoxyguanosine 108, abbreviated “G.” Each subunit 102, 104, 106, and 108 is generically referred to as a “deoxyribonucleotide,” and consists of a purine, in the case of A and G, or pyrimidine, in the case of C and T, covalently linked to a deoxyribose. The deoxyribonucleotide subunits are linked together by phosphate bridges, such as phosphate 110. The oligonucleotide shown in FIG. 1, and all DNA polymers, is asymmetric, having a 5′ end 112 and a 3′ end 114, each end comprising a chemically active hydroxyl group. RNA is similar, in structure, to DNA, with the exception that the ribose components of the ribonucleotides in RNA have a 2′ hydroxyl instead of a 2′ hydrogen atom, such as 2′ hydrogen atom 116 in FIG. 1, and include the ribonucleotide uridine, similar to thymidine but lacking the methyl group 118, instead of a ribonucleotide analog to deoxythymidine. The RNA subunits are abbreviated A, U, C, and G.

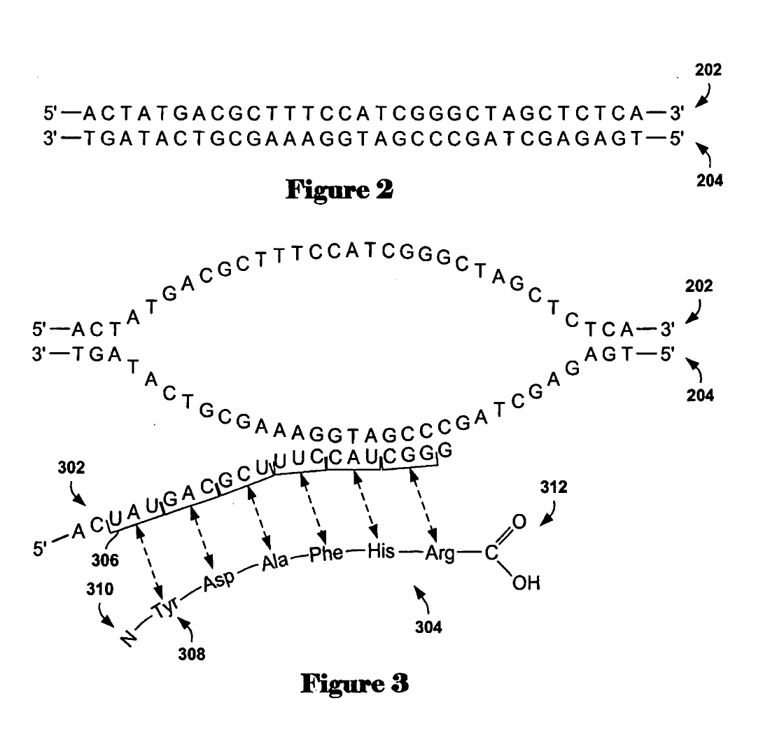

In cells, DNA is generally present in double-stranded form, in the familiar DNA-double-helix form. FIG. 2 shows a symbolic representation of a short stretch of double-stranded DNA. The first strand 202 is written as a sequence of deoxyribonucleotide abbreviations in the 5′ to 3′ direction and the complementary strand 204 is symbolically written in 3′ to 5′ direction. Each deoxyribonucleotide subunit in the first strand 202 is paired with a complementary deoxyribonucleotide subunit in the second strand 204. In general, a G in one strand is paired with a C in a complementary strand, and an A in one strand is paired with a T in a complementary strand. One strand can be thought of as a positive image, and the opposite, complementary strand can be thought of as a negative image, of the same information encoded in the sequence of deoxyribonucleotide subunits.

A gene is a subsequence of deoxyribonucleotide subunits within one strand of a double-stranded DNA polymer. One type of gene can be thought of as an encoding that specifies, or a template for, construction of a particular protein. FIG. 3 illustrates construction of a protein based on the information encoded in a gene. In a cell, a gene is first transcribed into single-stranded mRNA. In FIG. 3, the double-stranded DNA polymer composed of strands 202 and 204 has been locally unwound to provide access to strand 204 for transcription machinery that synthesizes a single-stranded mRNA 302 complementary to the gene-containing DNA strand. The single-stranded mRNA is subsequently translated by the cell into a protein polymer 304, with each three-ribonucleotide codon, such as codon 306, of the mRNA specifying a particular amino acid subunit of the protein polymer 304. For example, in FIG. 3, the codon “UAU” 306 specifies a tyrosine amino-acid subunit 308. Like DNA and RNA, a protein is also asymmetrical, having an N-terminal end 310 and a carboxylic acid end 312. Other types of genes include genomic subsequences that are transcribed to various types of RNA molecules, including catalytic RNAs, iRNAs, siRNAs, rRNAs, and other types of RNAs that serve a variety of functions in cells, but that are not translated into proteins. Furthermore, additional genomic sequences serve as promoters and regulatory sequences that control the rate of protein-encoding-gene expression. Although functions have not, as yet, been assigned to many genomic subsequences, there is reason to believe that many of these genomic sequences are functional. For the purpose of the current discussion, a gene can be considered to be any genomic subsequence.

In eukaryotic organisms, including humans, each cell contains a number of extremely long, DNA-double-strand polymers called chromosomes. Each chromosome can be thought of, abstractly, as a very long deoxyribonucleotide sequence. Each chromosome contains hundreds to thousands of subsequences, many subsequences corresponding to genes. The exact correspondence between a particular subsequence identified as a gene, in the case of protein-encoding genes, and the protein or RNA encoded by the gene can be somewhat complicated, for reasons outside the scope of the present invention. However, for the purposes of describing embodiments of the present invention, a chromosome may be thought of as a linear DNA sequence of contiguous deoxyribonucleotide subunits that can be viewed as a linear sequence of DNA subsequences. In certain cases, the subsequences are genes, each gene specifying a particular protein or RNA. Amplification and deletion of any DNA subsequence or group of DNA subsequences can be detected by comparative genomic hybridization, regardless of whether or not the DNA subsequences correspond to protein-sequence-specifying genes, to DNA subsequences specifying various types of RNAs, or to other regions with defined biological roles. The term “gene” is used in the following as a notational convenience, and should be understood as simply an example of a “biopolymer subsequence.” Similarly, although the described embodiments are directed to analyzing DNA chromosomal subsequences extracted from diseased tissues for amplification and deletion with respect to control tissues, the sequences of any information-containing biopolymer are analyzable by methods of the present invention. Therefore, the term “chromosome,” and related terms, are used in the following as a notational convenience, and should be understood as an example of a biopolymer or biopolymer sequence. In summary, a genome, for the purposes of describing the present invention, is a set of sequences. Genes are considered to be subsequences of these sequences. Comparative genomic hybridization techniques can be used to determine changes in copy number of any set of genes of any one or more chromosomes in a genome.

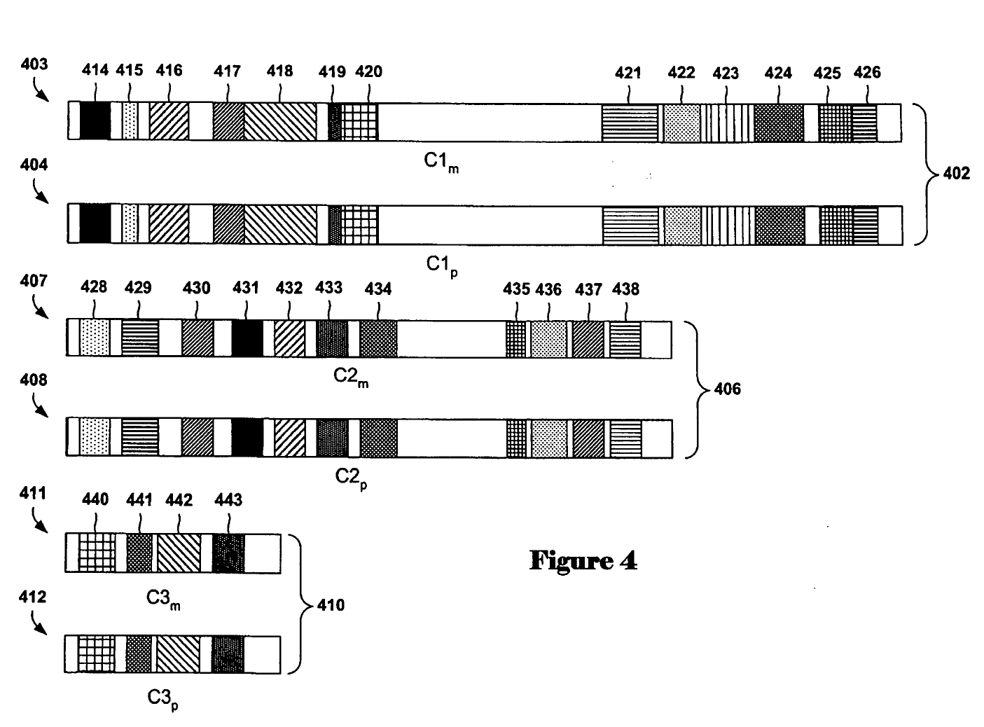

FIG. 4 shows a hypothetical set of chromosomes for a very simple, hypothetical organism. The hypothetical organism includes three pairs of chromosomes 402, 406, and 410. Each chromosome in a pair of chromosomes is similar, generally having identical genes at identical positions along the lines of the chromosome. In FIG. 4, each gene is represented as a subsection of the chromosome. For example, in the first chromosome 403 of the first chromosome pair 402, 13 genes are shown, 414-426.

As shown in FIG. 4, the second chromosome 404 of the first pair of chromosomes 402 includes the same genes, at the same positions, as the first chromosome. Each chromosome of the second pair of chromosomes 406 includes eleven genes 428-438, and each chromosome of the third pair of chromosomes 410 includes four genes 440-443. In a real organism, there are generally many more chromosome pairs, and each chromosome includes many more genes. However, the simplified, hypothetical genome shown in FIG. 4 is suitable for describing embodiments of the present invention. Note that, in each chromosome pair, one chromosome is originally obtained from the mother of the organism, and the other chromosome is originally obtained from the father of the organism. Thus, the chromosomes of the first chromosome pair 402 are referred to as chromosome “C1ₘ” and “C1ₚ” While, in general, each chromosome of a chromosome pair has the same genes positioned at the same location along the length of the chromosome, the genes inherited from one parent may differ slightly from the genes inherited from the other parent. Different versions of a gene are referred to as alleles. Common differences include single-deoxyribonucleotide-subunit substitutions at various positions within the DNA subsequence corresponding to a gene. Less frequent differences include translocations of genes to different positions within a chromosome or to a different chromosome, a different number of repeated copies of a gene, and other more substantial differences.

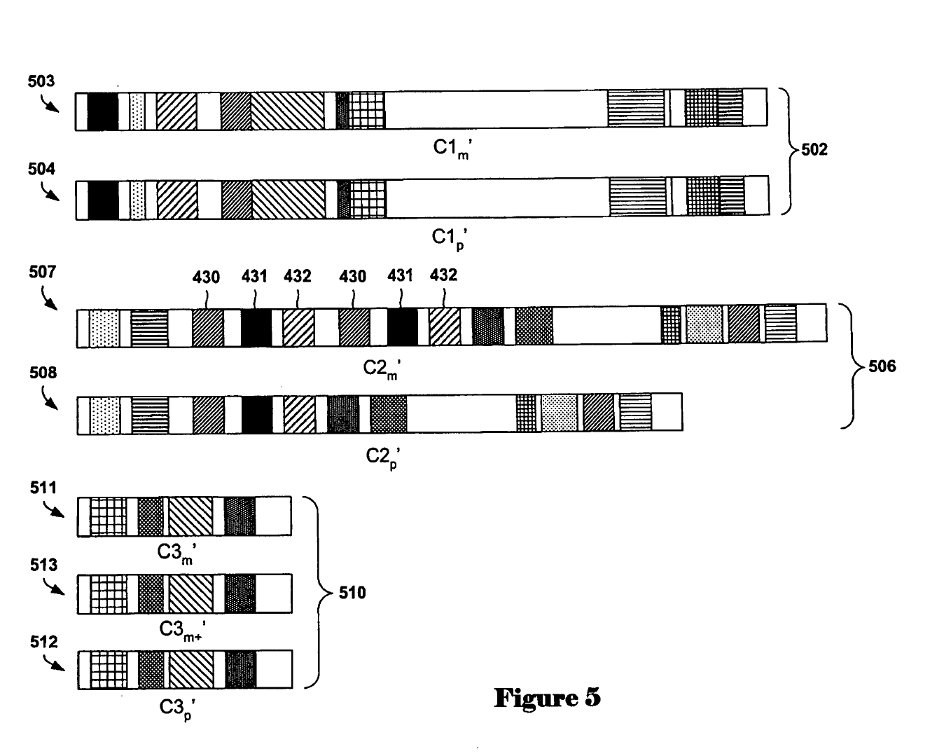

Although differences between genes and mutations of genes may be important in the predisposition of cells to various types of cancer, and related to cellular mechanisms responsible for cell transformation, cause-and-effect relationships between different forms of genes and pathological conditions are often difficult to elucidate and prove, and are very often indirect. However, other genomic abnormalities are more easily associated with pre-cancerous and cancerous tissues. Two such prominent types of genomic aberrations include gene amplification and gene deletion. FIG. 5 shows examples of gene deletion and gene amplification in the context of the hypothetical genome shown in FIG. 4. First, both chromosomes C1ₘ′ 503 and chromosome C1ₚ′ 504 of the variant, or abnormal, first chromosome pair 502 are shorter than the corresponding wild-type chromosomes C1ₘ and C1ₚ in the first pair of chromosomes 402 shown in FIG. 4. This shortening is due to deletion of genes 422, 423, and 424, present in the wild-type chromosomes 403 and 404, but absent in the variant chromosomes 503 and 504. This is an example of a double, or homozygous-gene-deletion. Small scale variations of DNA copy numbers can also exist in normal cells. These can have phenotypic implications, and can also be measured by CGH methods and analyzed by the methods of the present invention.

Generally, deletion of multiple, contiguous genes is observed, corresponding to the deletion of a substantial subsequence from the DNA sequence of a chromosome. Much smaller subsequence deletions may also be observed, leading to abnormal and often nonfunctional genes. A gene deletion may be observed in only one of the two chromosomes of a chromosome pair, in which case a gene deletion is referred to as being hemizygous.

A second chromosomal abnormality in the altered genome shown in FIG. 5 is duplication of genes 430, 431, and 432 in the maternal chromosome C2ₘ′ 507 of the second chromosome pair 506. Duplication of one or more contiguous genes within a chromosome is referred to as gene amplification. In the example altered genome shown in FIG. 5, the gene amplification in chromosome C2ₘ′ is heterozygous, since gene amplification does not occur in the other chromosome of the pair C2ₚ′ 508. The gene amplification illustrated in FIG. 5 is a two-fold amplification, but three-fold and higher-fold amplifications are also observed. An extreme chromosomal abnormality is illustrated with respect to the third chromosome pair (410 in FIG. 4). In the altered genome illustrated in FIG. 5, the entire maternal chromosome 511 has been duplicated from a third chromosome 513, creating a chromosome triplet 510 rather than a chromosome pair. This three-chromosome phenomenon is referred to as a trisomy. The trisomy shown in FIG. 5 is an example of heterozygous gene amplification, but it is also observed that both chromosomes of a chromosome pair may be duplicated, higher-order amplification of chromosomes may be observed, and heterozygous and hemizygous deletions of entire chromosomes may also occur, although organisms with such genetic deletions are generally not viable.

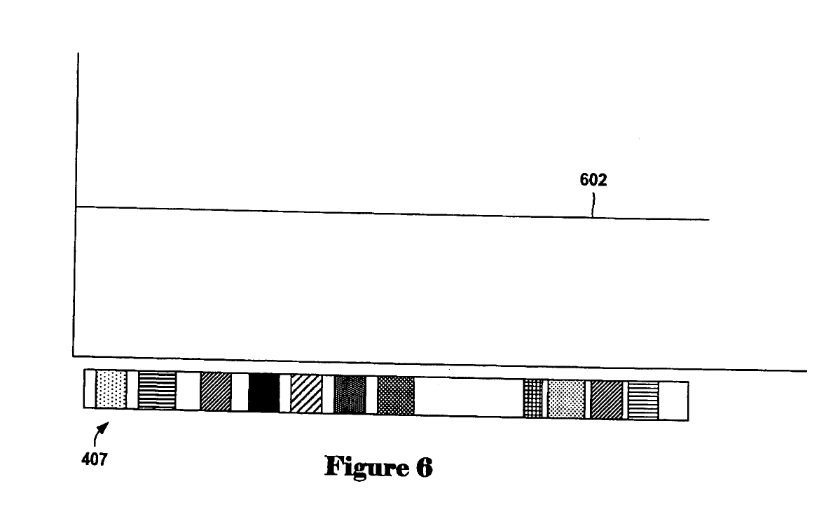

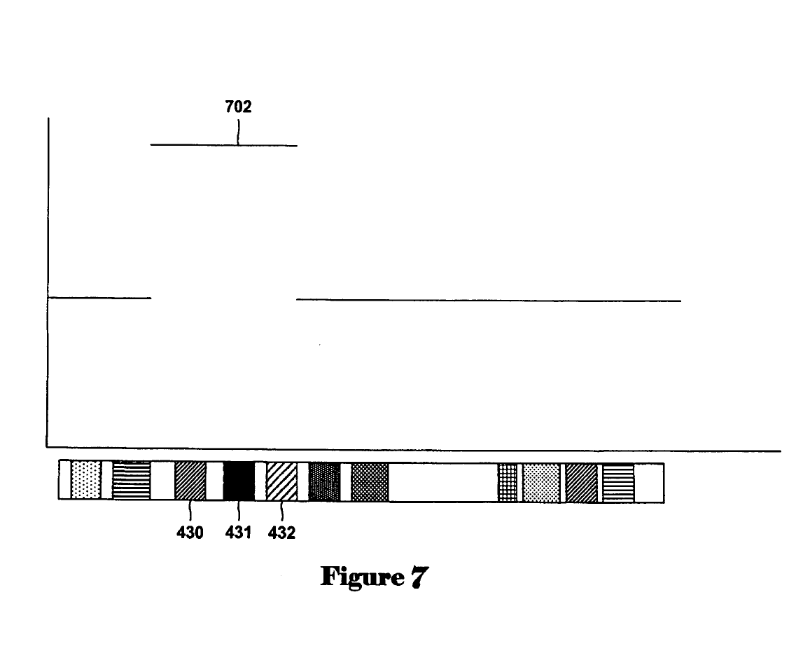

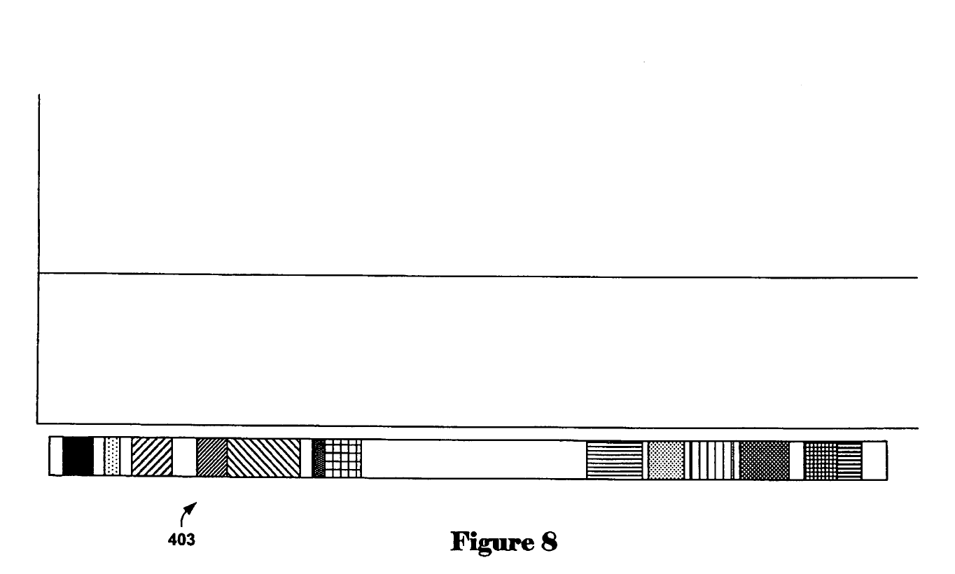

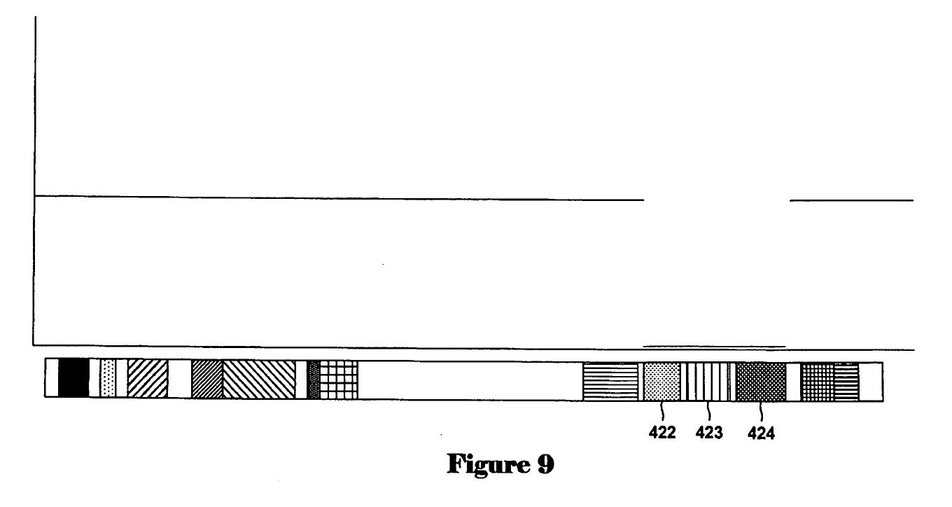

Changes in the number of gene copies, either by amplification or deletion, can be detected by comparative genomic hybridization (“CGH”) techniques. FIGS. 6-7 illustrate detection of gene amplification by CGH, and FIGS. 8-9 illustrate detection of gene deletion by CGH. CGH involves analysis of the relative level of binding of chromosome fragments from sample tissues to single-stranded, normal chromosomal DNA. The tissues-sample fragments hybridize to complementary regions of the normal, single-stranded DNA by complementary binding to produce short regions of double-stranded DNA. Hybridization occurs when a DNA fragment is exactly complementary, or nearly complementary, to a subsequence within the single-stranded chromosomal DNA. In FIG. 6, and in subsequent figures, one of the hypothetical chromosomes of the hypothetical wild-type genome shown in FIG. 4 is shown below the x axis of a graph, and the level of sample fragment binding to each portion of the chromosome is shown along the y axis. In FIG. 6, the graph of fragment binding is a horizontal line 602, indicative of generally uniform fragment binding along the length of the chromosome 407. In an actual experiment, uniform and complete overlap of DNA fragments prepared from tissue samples may not be possible, leading to discontinuities and non-uniformities in detected levels of fragment binding along the length of a chromosome. However, in general, fragments of a normal chromosome isolated from normal tissue samples should, at least, provide a binding-level trend approaching a horizontal line, such as line 602 in FIG. 6. By contrast, CGH data for fragments prepared from the sample genome illustrated in FIG. 5 should generally show an increased binding level for those genes amplified in the abnormal genotype.

FIG. 7 shows hypothetical CGH data for fragments prepared from tissues with the abnormal genotype illustrated in FIG. 5. As shown in FIG. 7, an increased binding level 702 is observed for the three genes 430-432 that are amplified in the altered genome. In other words, the fragments prepared from the altered genome should be enriched in those gene fragments from genes which are amplified. Moreover, in quantitative CGH, the relative increase in binding should be reflective of the increase in a number of copies of particular genes.

FIG. 8 shows hypothetical CGH data for fragments prepared from normal tissue with respect to the first hypothetical chromosome 403. Again, the CGH-data trend expected for fragments prepared from normal tissue is a horizontal line indicating uniform fragment binding along the length of the chromosome. By contrast, the homozygous gene deletion in chromosomes 503 and 504 in the altered genome illustrated in FIG. 5 should be reflected in a relative decrease in binding with respect to the deleted genes. FIG. 9 illustrates hypothetical CGH data for DNA fragments prepared from the hypothetical altered genome illustrated in FIG. 5 with respect to a normal chromosome from the first pair of chromosomes (402 in FIG. 4). As seen in FIG. 9, no fragment binding is observed for the three deleted genes 422, 423, and 424.

CGH data may be obtained by a variety of different experimental techniques. In one technique, DNA fragments are prepared from tissue samples and labeled with a particular chromophore. The labeled DNA fragments are then hybridized with single-stranded chromosomal DNA from a normal cell, and the single-stranded chromosomal DNA then visually inspected via microscopy to determine the intensity of light emitted from labels associated with hybridized fragments along the length of the chromosome. Areas with relatively increased intensity reflect regions of the chromophore amplified in the corresponding tissue chromosome, and regions of decreased emitted signal indicate deleted regions in the corresponding tissue chromosome. In other techniques, normal DNA fragments labeled with a first chromophore are competitively hybridized to a normal single-stranded chromosome with fragments isolated from abnormal tissue, labeled with a second chromophore. Relative binding of normal and abnormal fragments can be detected by ratios of emitted light at the two different intensities corresponding to the two different chromophore labels.

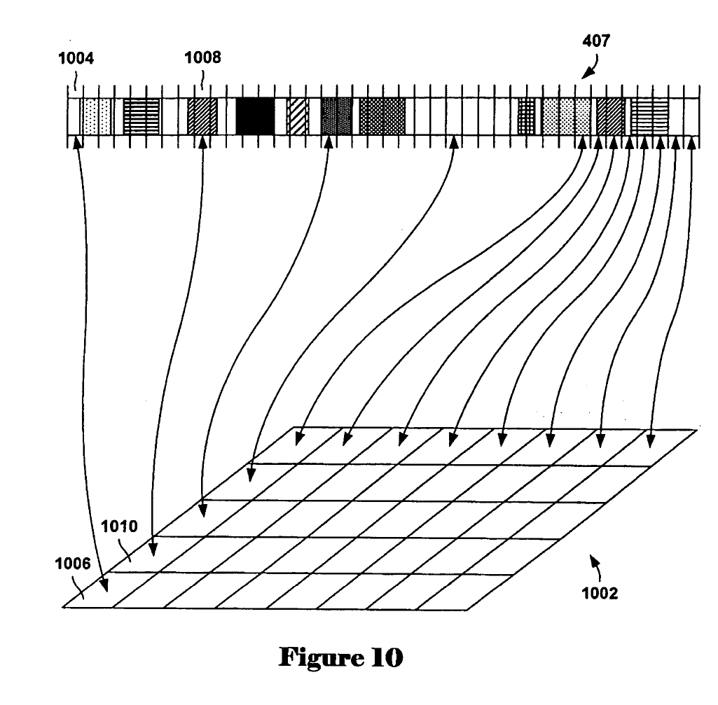

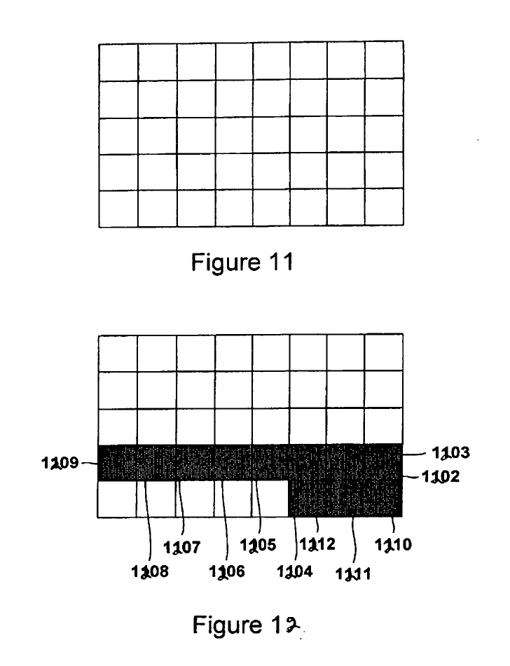

A third type of CGH is referred to as microarray-based CGH (“aCGH”). FIGS. 10-11 illustrate microarray-based CGH. In FIG. 10, synthetic probe oligonucleotides having sequences equal to contiguous subsequences of hypothetical chromosome 407 and/or 408 in the hypothetical, normal genome illustrated in FIG. 4 are prepared as features on the surface of the microarray 1002. For example, a synthetic probe oligonucleotide having the sequence of one strand of the region 1004 of chromosome 407 and/or 408 is synthesized in feature 1006 of the hypothetical microarray 1002. Similarly, an oligonucleotide probe corresponding to subsequence 1008 of chromosome 407 and 408 is synthesized to produce the oligonucleotide probe molecules of feature 1010 of microarray 1002. In actual cases, probe molecules may be much shorter relative to the length of the chromosome, and multiple, different, overlapping and non-overlapping probes/features may target a particular gene. Nonetheless, there is generally a definite, well-known correspondence between microarray features and genes, with the term “genes,” as discussed above, referring broadly to any biopolymer subsequence of interest. There are many different types of aCGH procedures, including the two-chromophore procedure described above, single-chromophore CGH on single-nucleotide-polymorphism arrays, bacterial-artificial-chromosome-based arrays, and many other types of aCGH procedures. The present invention is applicable to all aCGH variants. For each variant, data obtained by comparing signals generated by the variant with signals generated by a normal reference generally constitute a starting point for aCGH analysis. When single-dye technologies are used, multiple microarray-based procedures may be needed for aCGH analysis.

The microarray may be exposed to sample solutions containing fragments of DNA. In one version of aCGH, an array may be exposed to fragments, labeled with a first chromophore, prepared from potentially abnormal tissue as well as to fragments, labeled with a second chromophore, prepared from a normal or control tissue. The normalized ratio of signal emitted from the first chromophore versus signal emitted from the second chromophore for each feature provides a measure of the relative abundance of the portion of the normal chromosome corresponding to the feature in the abnormal tissue versus the normal tissue. In the hypothetical microarray 1002 of FIG. 10, each feature corresponds to a different interval along the length of chromosome 407 and 408 in the hypothetical wild-type genome illustrated in FIG. 4. When fragments prepared from a normal tissue sample, labeled with a first chromophore, and DNA fragments prepared from normal tissue labeled with the second chromophore, are both hybridized to the hypothetical microarray shown in FIG. 10, and normalized intensity ratios for light emitted by the first and second chromophores are determined, the normalized ratios for all features should be relatively uniformly equal to one.

FIG. 11 represents an aCGH data set for two normal, differentially labeled samples hybridized to the hypothetical microarray shown in FIG. 10. The normalized ratios of signal intensities from the first and second chromophores are all approximately unity, shown in FIG. 11, by log ratios for all features of the hypothetical microarray 1002 displayed in the same color. By contrast, when DNA fragments isolated from tissues having the abnormal genotype, illustrated in FIG. 5, labeled with a first chromophore are hybridized to the microarray, and DNA fragments prepared from normal tissue, labeled with a second chromophore, are hybridized to the microarray, then the ratios of signal intensities of the first chromophore versus the second chromophore vary significantly from unity in those features containing probe molecules equal to, or complementary to, subsequences of the amplified genes 430, 431, and 432. As shown in FIG. 12, increase in the ratio of signal intensities from the first and second chromophores, indicated by darkened features, are observed in those features 1202-1212 with probe molecules equal to, or complementary to, subsequences spanning the amplified genes 430, 431, and 432. Similarly, a decrease in signal intensity ratios indicates gene deletion in the abnormal tissues.

Microarray-based CGH data obtained from well-designed microarray experiments provide a relatively precise measure of the relative or absolute number of copies of genes in cells of a sample tissue. Sets of aCGH data obtained from pre-cancerous and cancerous tissues at different points in time can be used to monitor genome instability in particular pre-cancerous and cancerous tissues. Quantified genome instability can then be used to detect and follow the course of particular types of cancers. Moreover, quantified genome instabilities in different types of cancerous tissue can be compared in order to elucidate common chromosomal abnormalities, including gene amplifications and gene deletions, characteristic of different classes of cancers and pre-cancerous conditions, and to design and monitor the effectiveness of drug, radiation, and other therapies used to treat cancerous or pre-cancerous conditions in patients. Unfortunately, biological data can be extremely noisy, with the noise obscuring underlying trends and patterns. Scientists, diagnosticians, and other professionals have therefore recognized a need for statistical methods for normalizing and analyzing aCGH data, in particular, and CGH data in general, in order to identify signals and patterns indicative of chromosomal abnormalities that may be obscured by noise arising from many different kinds of experimental and instrumental variations.

One approach to ameliorating the effects of high noise levels in CGH data involves normalizing sample-signal data by using control signal data. Features can be included in a microarray to respond to genome targets known to be present at well-defined multiplicities in both sample genome and the control genome. Control signal data can be used to estimate an average ratio for abnormal-genome-signal intensities to control-genome-signal intensities, and each abnormal-genome signal can be multiplied by the inverse of the estimated ratio, or normalization constant, to normalize each abnormal-genome signal to the control-genome signals. Another approach is to compute the average signal intensity for the abnormal-genome sample and the average signal intensity for the control-genome sample, and to compute a ratio of averages for abnormal-genome-signal intensities to control-genome-signal intensities based on averaged signal intensities for both samples.

In a more general case, an aCGH array may contain a number of different features, each feature generally containing a particular type of probe, each probe targeting a particular chromosomal DNA subsequence indexed by index k that represents a genomic location. A subsequence indexed by index k is referred to as “subsequence k.” One can define the signal generated for subsequence k as the sum of the normalized log-ratio signals from the different probes targeting subsequence k divided by the number of probes targeting subsequence k or, in other words, the average log-ratio signal value generated from the probes targeting subsequence k, as follows:

$$C ( k ) = \frac{{\sum }_{b ∈ \{ feature containing probes for k \}} C ( b )}{{num\_features}_{k}}$$

where num_featuresₖ is the number of features that target the subsequence k; and C(b) is the normalized log-ratio signal measured for feature b,

$${log ( \frac{{I}_{red}}{{I}_{green}} )}_{b} - \frac{{\sum }_{i ∈ \{ all features \}} {log ( \frac{{I}_{red}}{{I}_{green}} )}_{i}}{num\_features}$$

In the case where a single probe targets a particular subsequence, k, no averaging is needed. In the following discussion, normalization of signals for a solution of interest is discussed, such as a solution of DNA fragments obtained from a particular tissue or experiment. A solution of interest may be subject to a single CGH analysis, or a number of identical samples derived from the solution of interest may be each separately subject to CGH analysis, and the signals produced by the analysis for each subsequence k may be averaged to produce a single, averaged, signal data set for the solution of interest.

To re-emphasize, each aCGH data point is generally a log ratio of signals read from a particular feature of a microarray that contains probes targeting a particular subsequence, the log-ratio of signals representing the ratio of signals emitted from a first label used to label fragments of a genome sample to a signal generated from a second label used to label fragments of a normal, control genome. Both the sample-genome fragments and the normal, control fragments hybridize to normal-tissue-derived probe molecules on the microarray. A normal tissue or sample may be any tissue or sample selected as a control tissue or sample for a particular experiment. The term “normal” does not necessarily imply that the tissue or sample represents a population average, a non-diseased tissue, or any other subjective or object classification. The sample genome may be obtained from a diseased or cancerous tissue, in order to compare the genetic state of the diseased or cancerous tissue to a normal tissue, but may also be a normal tissue.

Subsequence deletions and amplifications generally span a number of contiguous subsequences of interest, such as genes, control regions, or other identified subsequences, along a chromosome. It therefore makes sense to analyze aCGH data in a chromosome-by-chromosome fashion, statistically considering groups of consecutive subsequences along the length of the chromosome in order to more reliably detect amplification and deletion. Specifically, it is assumed that the noise of measurement is independent for each subsequence along the chromosome, and independent for distinct probes. Statistical measures are employed to identify sets of consecutive subsequences for which deletion or amplification is relatively strongly indicated. This tends to ameliorate the effects of spurious, single-probe anomalies in the data. This is an example of an aberration-calling technique, in which gene-copy anomalies appearing to be above the data-noise level are identified.

One can consider the measured, normalized, or otherwise processed signals for subsequences along the chromosome of interest to be a vector V as follows:
V={v₁,v₂, . . . , vₙ}
where vₖ=C(k)
Note that the vector, or set V, is sequentially ordered by position of subsequences along the chromosome. A statistic S is computed for each interval I of subsequences along the chromosome as follows:

$$S ( I ) = ( {\sum }_{k = i , … , j} {v}_{k} ) \cdot \frac{1}{\sqrt{j - i + 1}}$$

$$where$$

$$I = \{ {v}_{i} , … , {v}_{j} \} ;$$

$$and$$

$${v}_{k} = C ( k )$$

Under a null model assuming no sequence aberrations, the statistic S has a normal distribution of values with mean=0 and variance=1, independent of the number of probes included in the interval I. The statistical significance of the normalized signals for the subsequences in an interval I can be computed by a standard probability calculation based on the area under the normal distribution curve:

$$Prob ( \vert S ( I ) \vert > z ) \approx ( \frac{1}{\sqrt{2 π}} ) \frac{1}{z} {ⅇ}^{- \frac{{z}^{2}}{2}}$$

Alternatively, the magnitude of S(I) can be used as a basis for determining alteration.

It should be noted that various different interval lengths may be used, iteratively, to compute amplification and deletion probabilities over a particular biopolymer sequence. In other words, a range of interval sizes can be used to refine amplification and deletion indications over the biopolymer.

After the probabilities for the observed values for intervals are computed, those intervals with computed probabilities outside of a reasonable range of expected probabilities under the null hypothesis of no amplification or deletion are identified, and redundancies in the list of identified intervals are removed. FIG. 13 illustrates one method for identifying and ranking intervals and removing redundancies from lists of intervals identified as corresponding to probable deletions or amplifications. In FIG. 13, the intervals for which probabilities are computed along the chromosome Cₗ (402 in FIG. 4) for diseased tissue with an abnormal chromosome (502 in FIG. 5) are shown. Each interval is labeled by an interval number, Iₓ, where x ranges from 1 to 9. For most intervals, the calculated probability falls within a range of probabilities consonant with the null hypothesis. In other words, neither amplification nor deletion is indicated for most of the intervals. However, for intervals I₆ 1302, I₇, 1304, and I₈, 1306, the computed probabilities fall below the range of probabilities expected for the null hypothesis, indicating potential subsequence deletion in the diseased-tissue sample. These three intervals are placed into an initial list 1308 which is ordered by the significance of the computed probability into an ordered list 1310. Note that interval I₇ 1304 exactly includes those subsequences deleted in the diseased-tissue chromosome (502 in FIG. 5), and therefore reasonably has the highest significance with respect to falling outside the probability range of the null hypothesis. Next, all intervals overlapping an interval occurring higher in the ordered list are removed, as shown in list 1312, where overlapping intervals I₆ and I₈, with less significance, are removed, as indicated by the character X placed into the significance column for the entries corresponding to intervals I₆ and I₈. The end result is a list containing a single interval 1314 that indicates the interval most likely coinciding with the deletion. The final list for real chromosomes, containing thousands of subsequences and analyzed using hundreds of intervals, may generally contain more than a single entry. Additional details regarding computation of interval scores can be found in “Efficient Calculation of Interval Scores for DNA Copy Number Data Analysis,” Lipson et al., Proceedings of RECOMB 2005, LNCS 3500, p. 83, Springer-Verlag.

### EMBODIMENTS OF THE PRESENT INVENTION

Method and system embodiments of the present invention may employ any of numerous different aberration-calling methods for analyzing aCGH data to determine regions of amplification and deletion, including the interval-based methods outlined in the previous subsection. The products of the aberration-calling methods are indications of the relative abundance of subsequences of a sample genome with respect to a control genome after the signal data has been normalized and analyzed by an aberration-calling method that identifies indications of subsequence deletion and amplifications that are significant with respect to signal noise.

FIGS. 14A-C illustrate hypothetical red/green data for three hypothetical chromosomes that are used in the following discussion to illustrate problems addressed by methods and systems of the present invention. In FIGS. 14A-C, the three hypothetical chromosomes are represented by horizontal lines 1402-1404. The red data is shown above the horizontal line, and the green data is shown below the horizontal line, for each subsequence of each chromosome. Each hypothetical chromosome has 64 probe-complementary subsequences, each subsequence represented by a left-pointing arrow-like structure, with the red intensity value plotted above the horizontal line, and the green intensity value plotted below the horizontal line. For the sake of simplicity, the subsequences are considered to have uniform lengths.

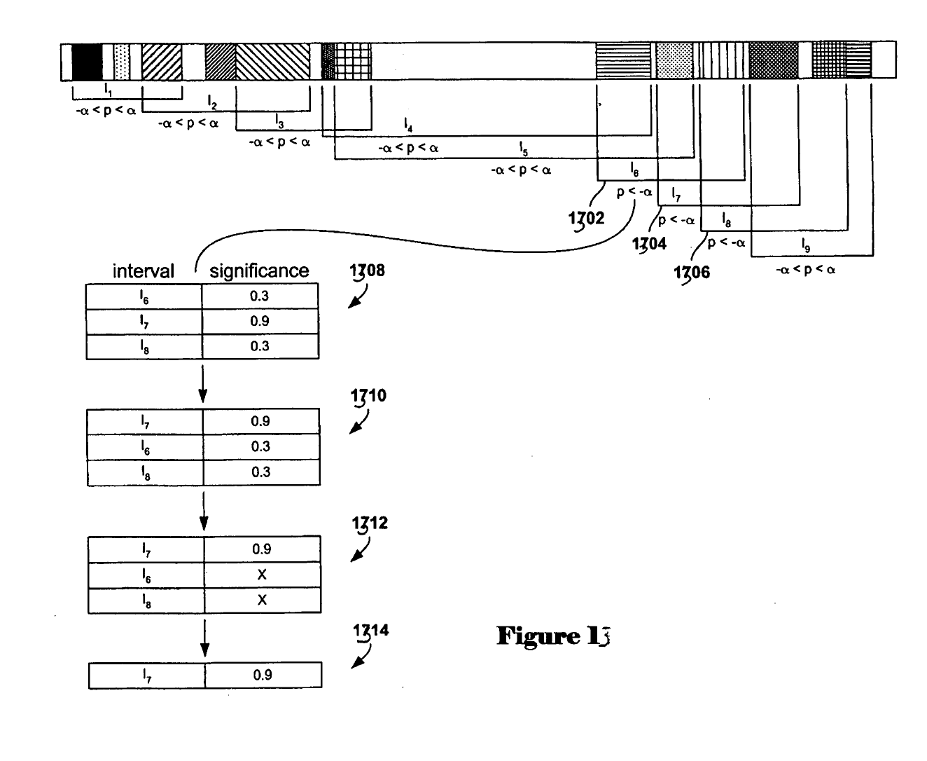

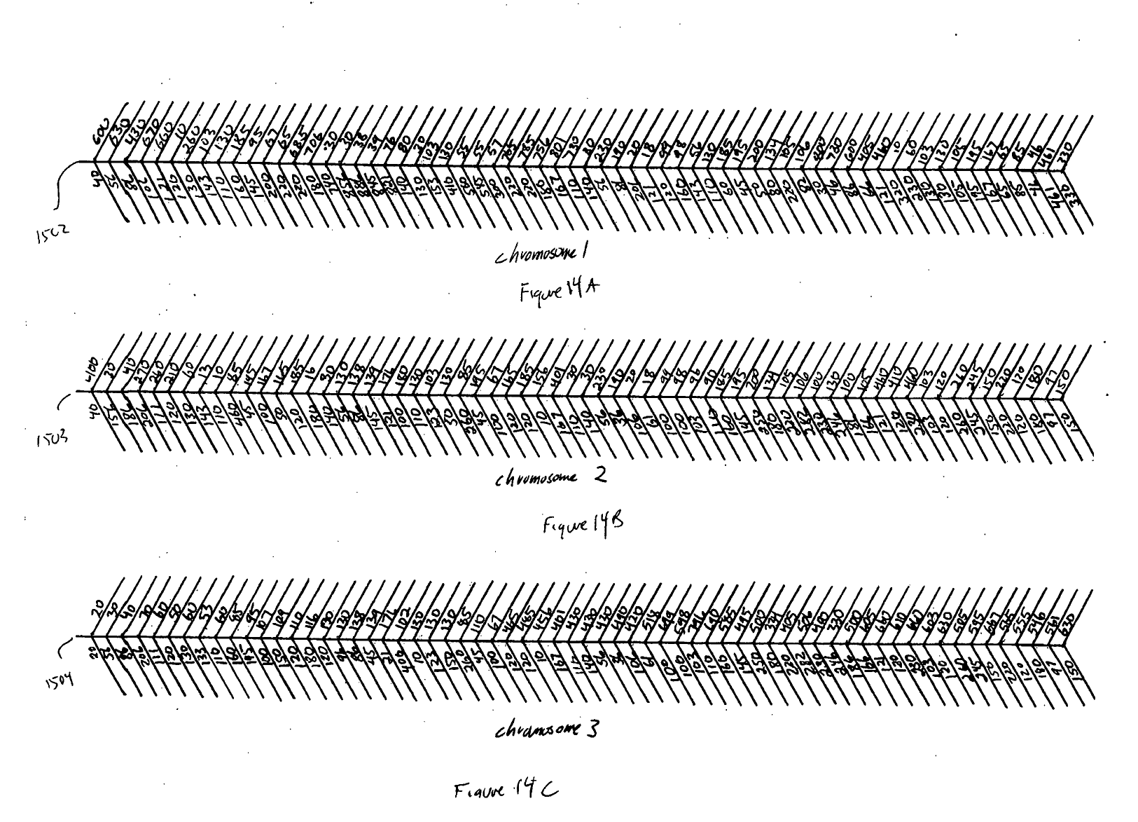

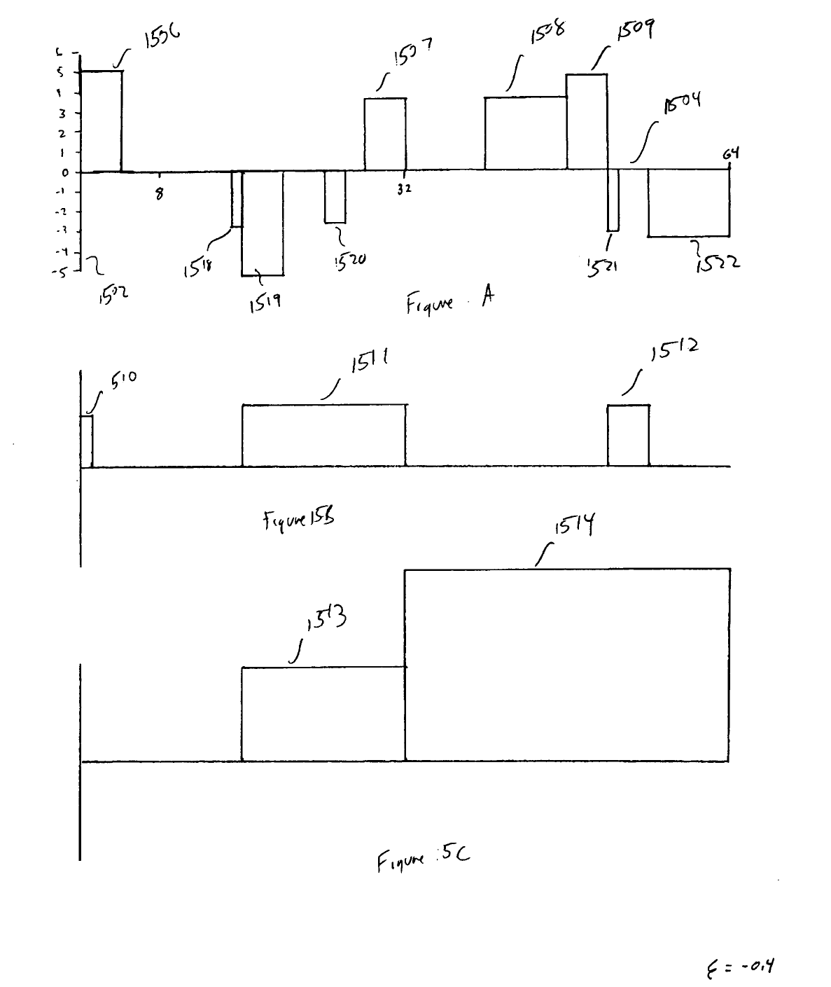

FIGS. 15A-19C show plots of the amplified and deleted regions of the three hypothetical chromosomes shown in FIGS. 14A-C determined by applying an aberration-calling method, such as an interval-based method as described above, to the hypothetical red/green data for the three hypothetical chromosomes shown in FIGS. 14A-C, using a range of candidate centralization constants or zero points. All of FIGS. 15A-19C use the same illustration conventions, next described with reference to FIG. 15A. FIGS. 15A-19C are specifically generated using an interval-based aberration-calling method where a score S(I) is computed for each interval I:

$$S ( I ) = \frac{1}{\sqrt{\vert I \vert}} {\sum }_{j ∈ I} ( ln ( \frac{{R}_{j}}{{G}_{j}} ) - ζ )$$

where the sum is over all probes in the interval I;

Rⱼ and Gⱼ represent the red and green signal for the j-th probe, respectively;

|I| is the number of probes in I; and

ζ is a centralization constant for the data.

FIGS. 15A-19C are generated using an interval-based aberration-calling mechanism similar to the one discussed above, but which uses signals shifted by a candidate zero value ζ, so that a score S(I) is computed for each interval I.

FIG. 15A shows a plot, generated by an interval-based analysis of the aCGH data shown in FIG. 14A. Only amplifications and deletions are shown. Each plot features a vertical axis 1502 corresponding to computed S(I) values for each of the amplified and deleted regions, and a horizontal axis 1504 representing, in the case of FIG. 15A, hypothetical chromosome 1, incremented in probe-complementary subsequences. The plot shown in FIG. 15A for hypothetical chromosome 1, and the plots shown in FIGS. 15B-C for hypothetical chromosomes 2 and 3, respectively, are generated by using a zero-point value, or candidate centralization constant ζ, of −0.4. As can be seen in FIG. 15A-C, the aberration-calling method identifies a large number of amplified regions 1506-1514 throughout the three hypothetical chromosomes, and five deleted regions 1518-1522 in the first hypothetical chromosome.

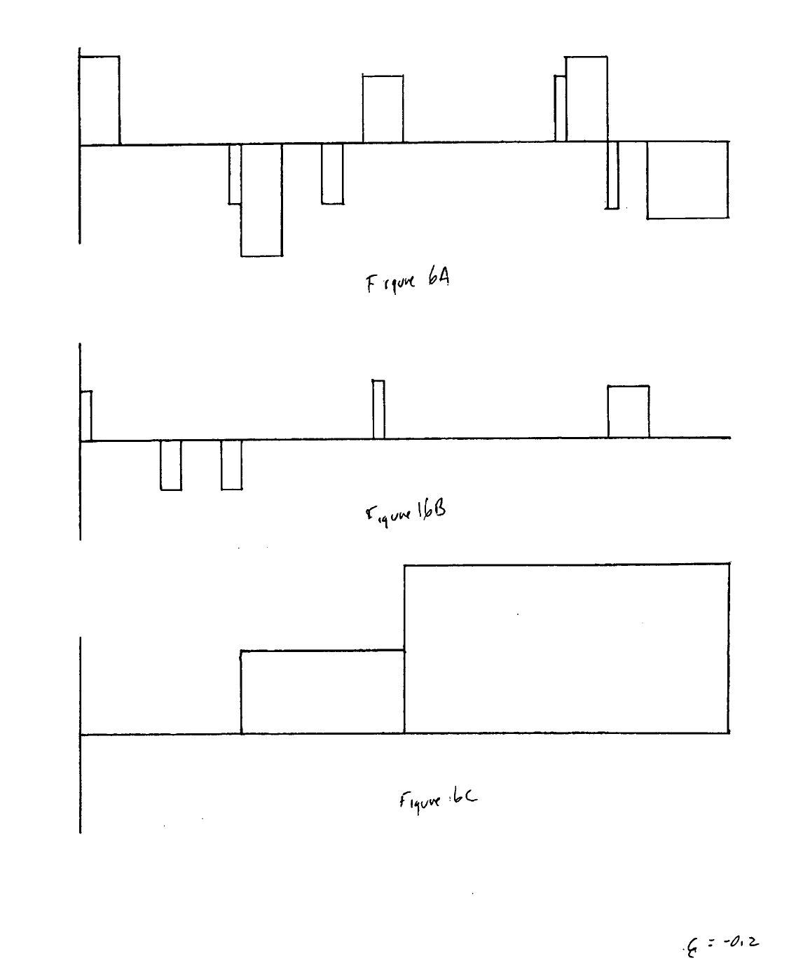

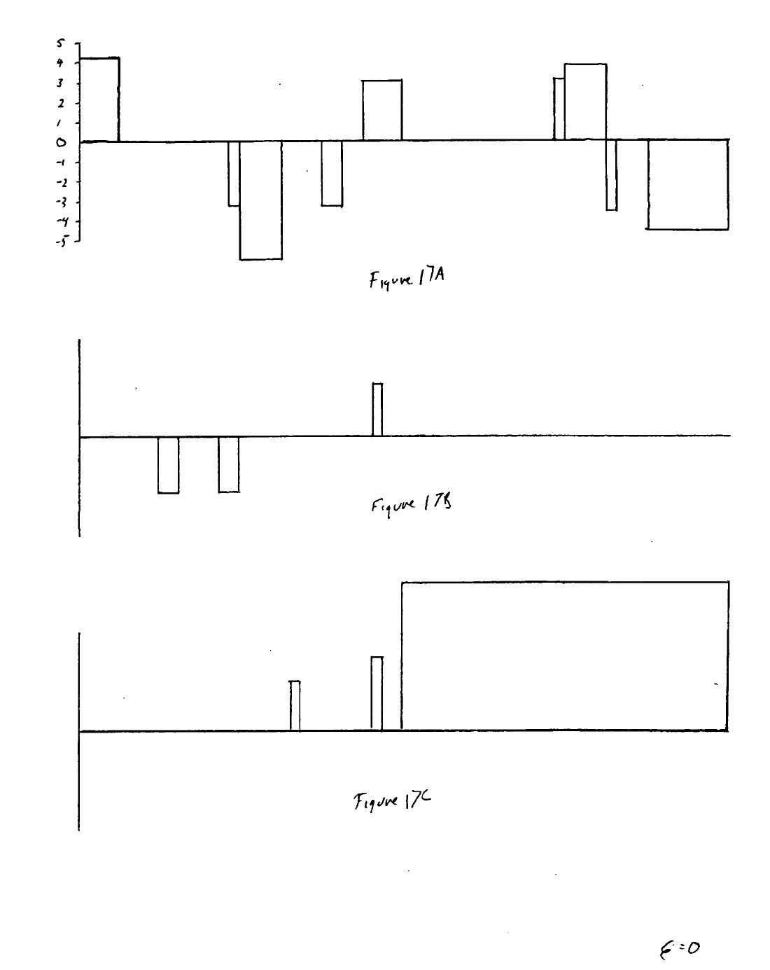

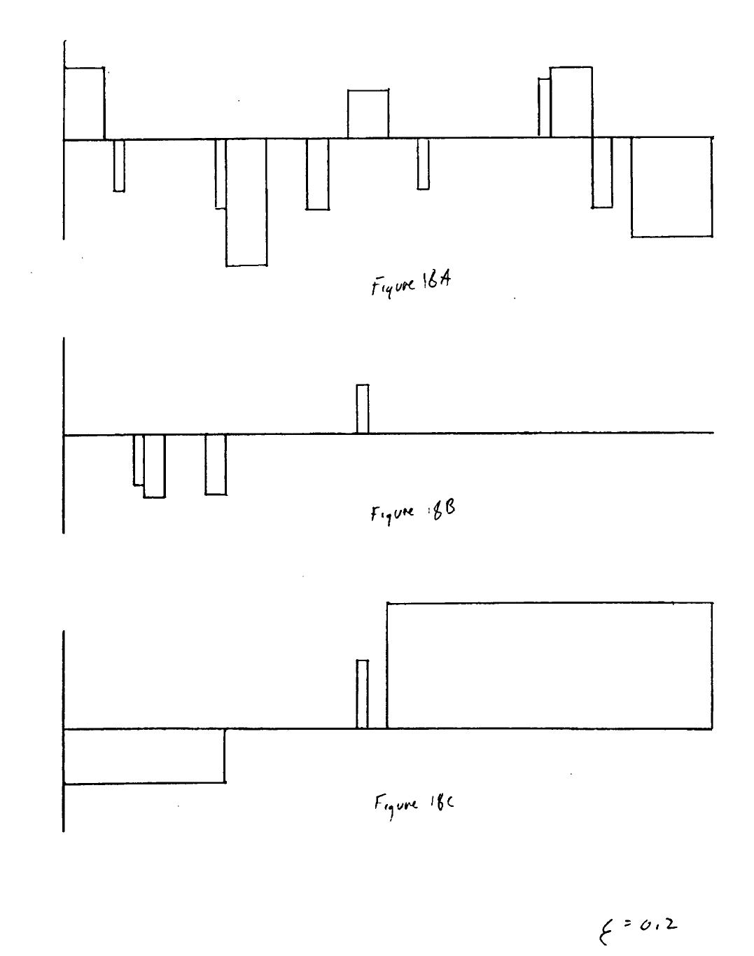

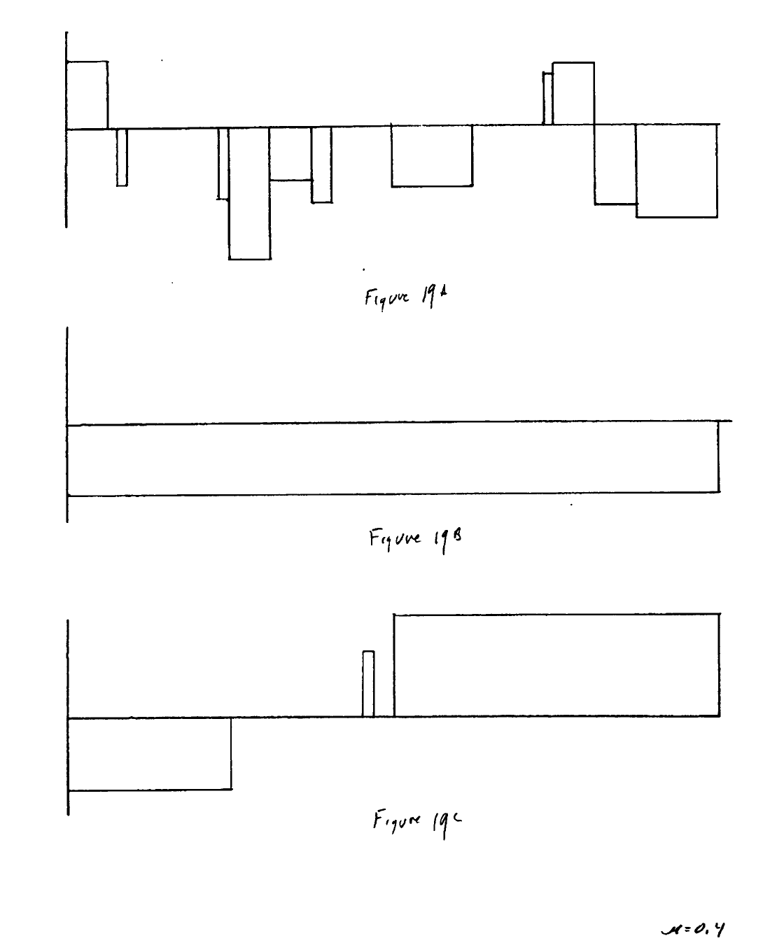

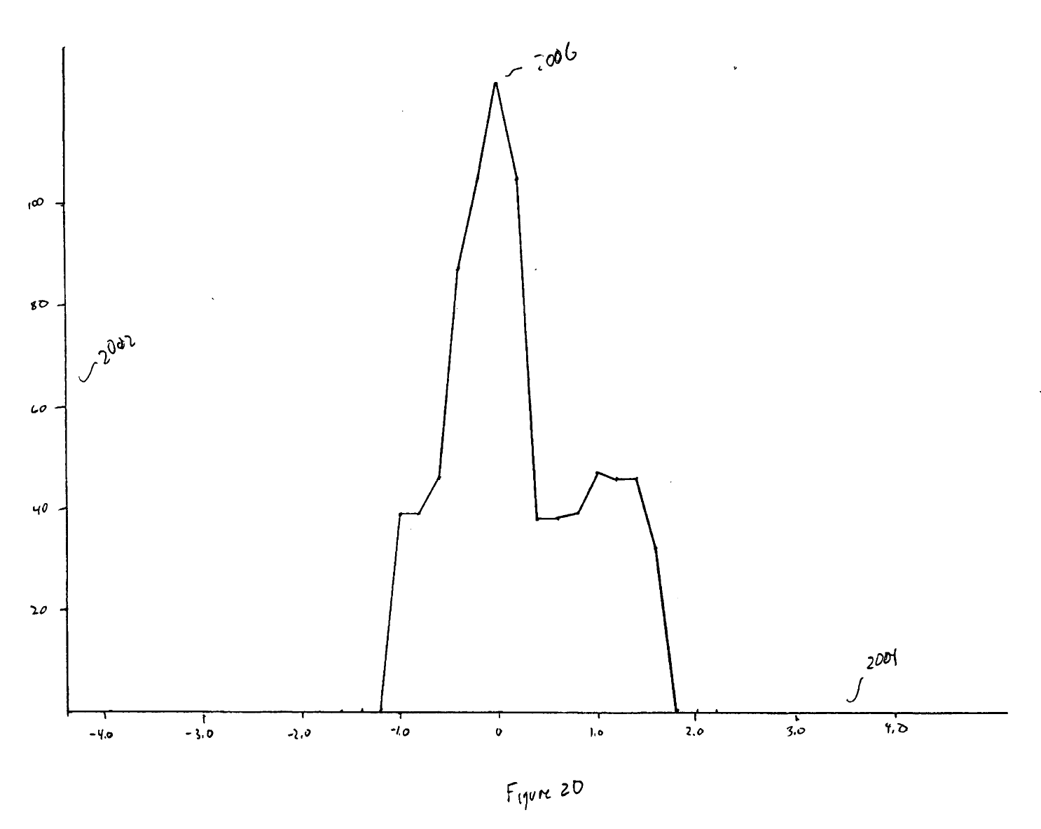

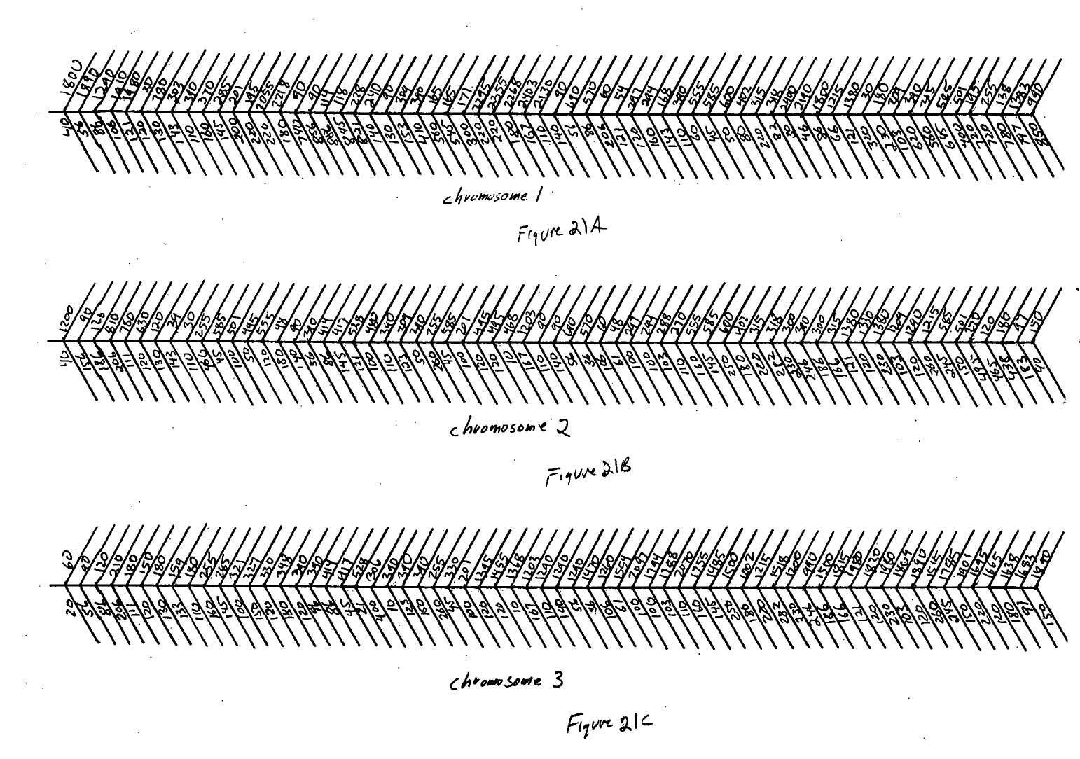

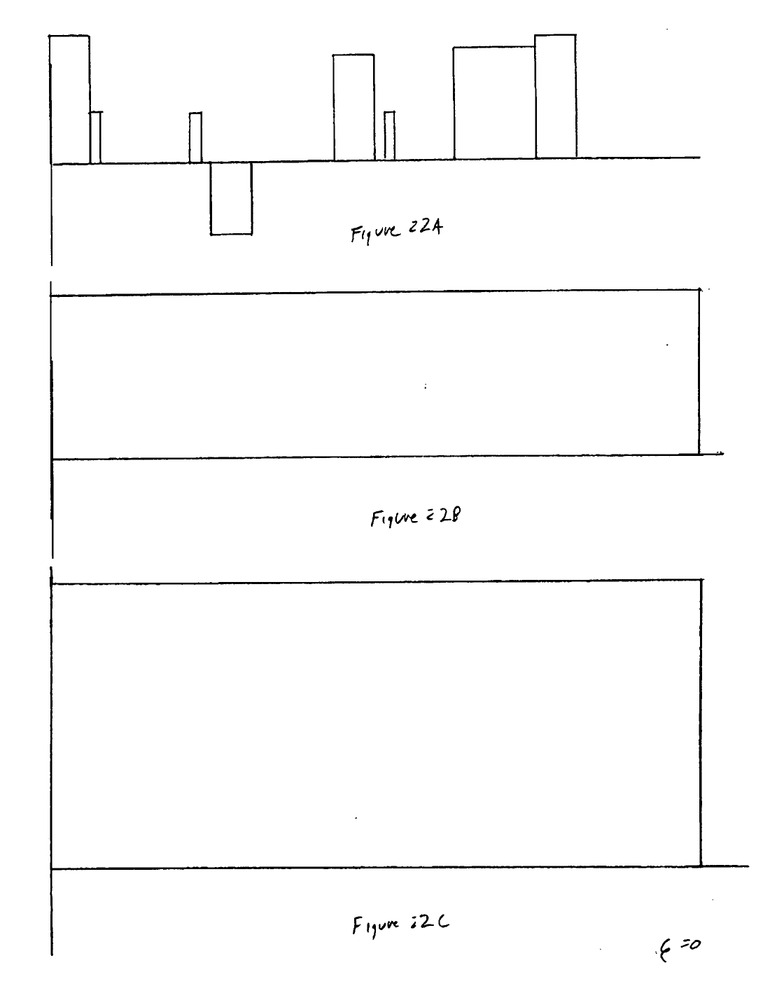

FIGS. 16A-C show plots of regions of amplification and deletion in the three hypothetical chromosomes determined by the aberration-calling method using a zero-point value, or candidate centralization constant ζ, of −0.2. FIGS. 17A-C show amplification/deletion plots generated by the aberration-calling method using a zero-point value of 0.0, FIGS. 18A-18C show amplification/deletion plots generated by the aberration-calling method using a zero-point value of 0.2, and FIGS. 19A-19C show amplification/deletion plots generated by the aberration-calling method using a zero-point value of 0.4. Comparing FIGS. 15A-C to FIGS. 19A-C, it is readily observable that using a negative zero-point value tends to produce a greater number of amplified regions, while using a large-magnitude, positive zero-point value tends to produce a greater number of deleted regions. This result is not surprising, in view of the subtraction of ζ from the log ratio observed for each subsequence within each interval to compute the S(I) score. Observing the entire range of plotted deletions and amplifications using the range of zero-point values from −0.4 to 0.4, it is readily seen that, although the general patterns of amplified and deleted regions are at least partially preserved throughout the range, the apparent resolution of the interval-based method appears to increase as the zero-point value increases from −0.4 to 0 and then appears to decrease as the zero-point value increases from 0 to 0.4. Moreover, the magnitudes of the S(I) scores computed for the intervals appear to be of smaller, overall magnitude when computed using a zero-point value of 0, and appear to be exaggerated at the extreme zero-point values of −0.4 and 0.4.

In general, the zero-point value is not known for aCGH data sets obtained through common experimental methods. An initial value can be computed, but, in general, initial computed values are not estimates of the true zero-point value. For example, an approach of choosing a centralization constant to minimize the log ratios computed from the red/green aCGH data would not be expected to provide an accurate centralization constant, since significant regions of amplification or deletion would cause the theoretically accurate centralization constant to be non-zero. Furthermore, the aCGH data distributions cannot be expected to be normally distributed. Use of control features may provide an estimate, but there are many problems associated with a control-feature approach, as well.

As can be seen in the hypothetical deletion and amplification plots of FIGS. 15A-19C, an arbitrary choice of zero-point values may greatly affect the results of the analysis. When aCGH data analysis is employed to identify amplified and deleted regions in the genomes of cancer cells, the problem of assigning zero-point values for aberration-calling analysis may be quite severe, owing to increased ploidity of many cancer tissues. It is common, in late stage cancers, to observe two, three, and greater-fold duplication of most or all chromosomes. Owing to increased ploidity, cancer tissue samples may include a two-fold or greater increase in the number of copies of any particular chromosome subsequence relative to samples extracted from normal tissues. Zero-point problems arise with particular severity when the overall ploidity is increased in the cancer tissues, but certain regions or chromosomes have different copy numbers than would be expected based on the overall ploidity. In such cases, analysis of the aCGH data for identifying amplified and deleted regions over the overall ploidity-change background is effective only when a zero-point value is chosen that is reasonably close to a theoretically accurate normalization ratio for red-to-green log ratios representative. In such cases, a naïve normalization approach may lead to widespread misidentification of amplified and deleted regions. Even in aCGH data sets without large-scale aneuploidy, use of inappropriate zero-point values during aberration-calling analysis can lead to annoying shifts of the resulting step-like amplification and deletion profiles, leading, in turn, to misidentification of normal-copy-number regions as being either amplified or deleted. For all of these reasons, designers of microarray-data analytical tools and programs, vendors of microarray-based instruments, and researchers who employ aCGH analysis to identify and track subsequence-copy-number abnormalities in the genomes of tissue samples have all recognized the need for a reliable method for identifying reasonable zero-point values or, in other words, normalization ratios ζ.

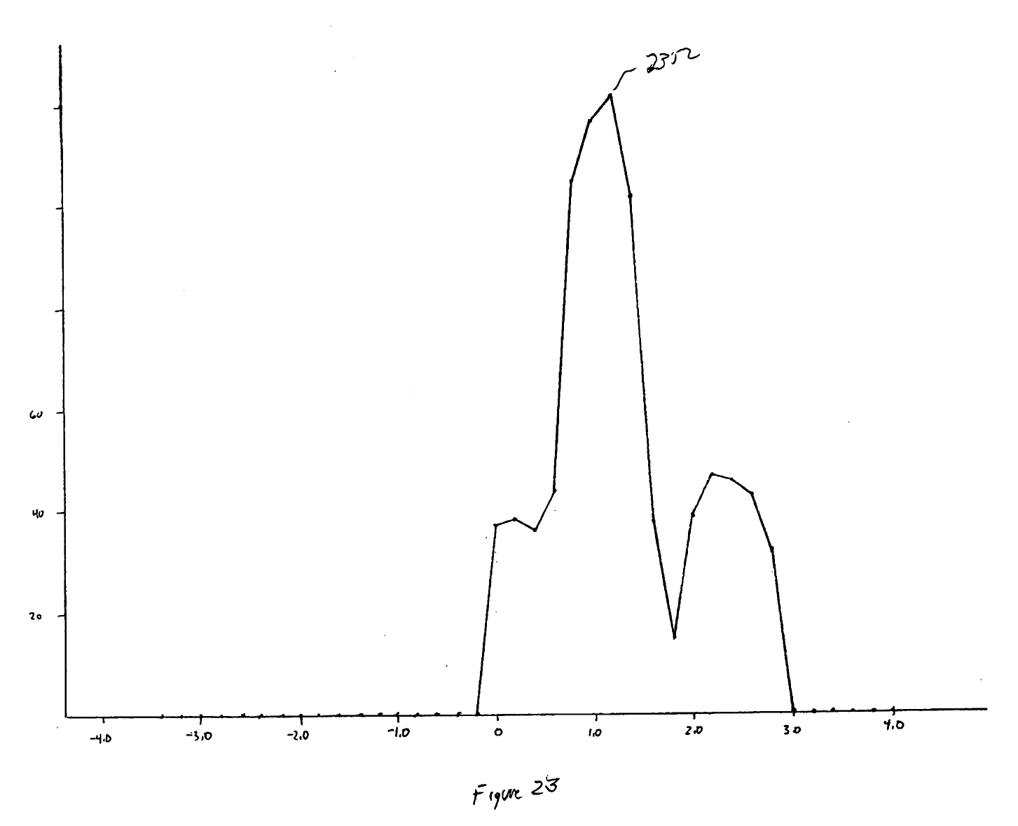

An important observation follows from considering a graph of the number of normal chromosome subsequences in the hypothetical chromosomes, red/green data for which are shown in FIGS. 14A-C, obtained by aberration-calling analysis using a range of ζ values. FIG. 20 shows a plot of the number of normal-copy-number chromosome subsequences returned by calls to the aberration-calling method using ζ values in a range from −4.0 through 4.0, with 0.2 increments. In FIG. 20, the vertical axis 2002 corresponds to the normal copy number of chromosome subsequences, and the horizontal axis 2004 corresponds to the ζ value used in the aberration-calling analysis. As readily observed in FIG. 20, there is a sharp peak 2006 corresponding to the ζ value of 0.0. Again comparing the aberration-calling aCGH analysis results shown in FIGS. 15A-19C, it is apparent that the plots shown in FIGS. 17A-C, generated using a ζ value of 0.0, appear to have the highest resolution and show amplified and deleted regions with the lowest, overall S(I) magnitudes.

The results shown in FIGS. 15A-20 motivate a method for determining a zero-point value, or centralization constant ζ, for aCGH data sets that is consonant with a general scientific principle referred to as Occam's Razor. According to this principle, one should employ as simple a model as possible to explain any particular observed phenomenon. Although Occam's Razor does not always produce a best model or best explanation, and although some relatively simple patterns and phenomena are known to result from quite complex processes, Ocaam's razor has proved to be a useful and well-proven guide for devising models to explain observed phenomena. Methods and systems of the present invention employ an Occam's-Razor-like approach to assigning a zero-point value to an aCGH data set. The approach of method embodiments of the present invention is to assign to an aCGH data set a zero-point value that produces the largest number of normal-copy-number chromosome subsequences by interval-based aCGH analysis, or any other aberration-calling method. Alternatively, this approach may be viewed as assigning to an aCGH data set a zero-point value that produces the smallest number of abnormal copy-number chromosome subsequences by interval-based aCGH analysis or another aberration-calling method. Many experiments using this approach have verified that selecting a zero-point value that produces the least number of abnormal-copy-number chromosome subsequences by interval-based analysis, or another method of aberration calling, using the zero-point value does, in fact, generally produce a correct zero-point value, or centralization constant ζ. It should be noted that the minimization may be directed to minimizing the number of probes for which the complementary target sequences are called out as aberrant, minimizing the length of genomic subsequences called out as aberrant, or minimizing some computed metric or computed values, such as weighted genomic subsequence lengths, sum of probe weights, or other metrics or computed values.

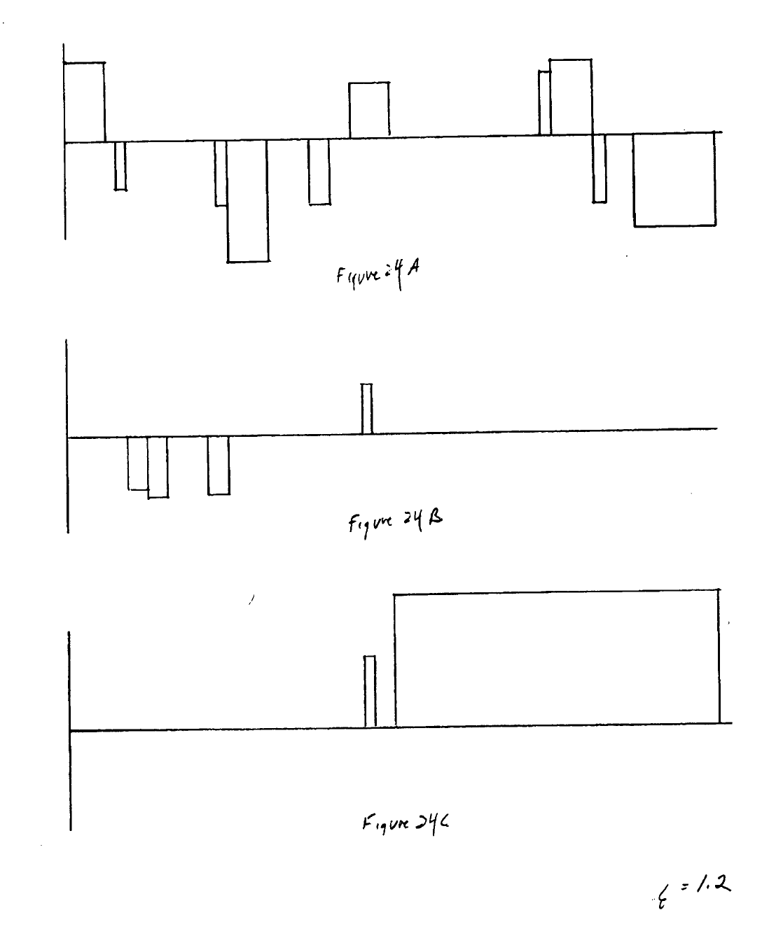

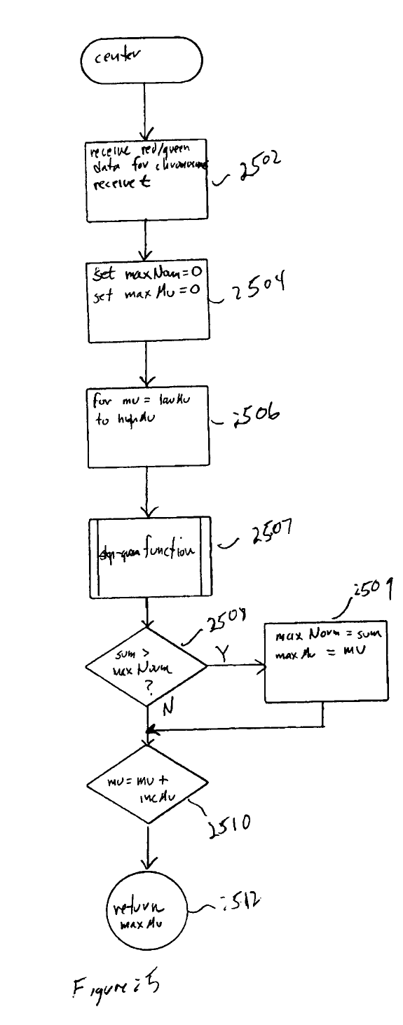

The approach of method embodiments of the present invention is particularly useful for increased ploidity samples often obtained from cancerous tissues. FIGS. 21A-C show red/green data for the hypothetical three chromosomes, as shown in FIGS. 14A-C, with the red signal increased approximately by a factor of three with respect to the red signal in the hypothetical examples shown in FIGS. 14A-C. FIGS. 22A-C show amplification/deletion plots generated by an aberration-calling method using a zero-point value of 0.0. In this case, all of chromosomes 2 and 3 appear to be amplified, and a significant amount of the detail observed in FIG. 17A appears to be missing or misinterpreted in corresponding FIG. 22A. In other words, because of the effective three-fold ploidity of the red data with respect to the green data, the high-resolution, relative gene-expression differences observed in FIG. 17A-C have been lost.

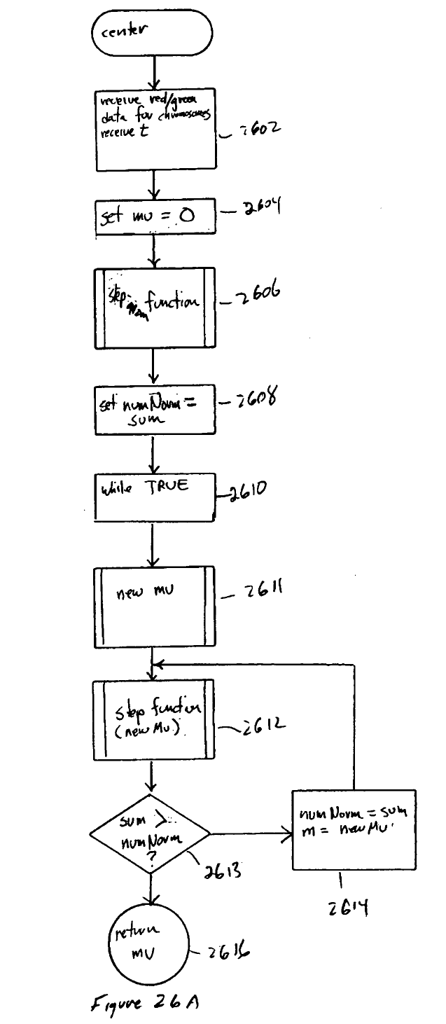

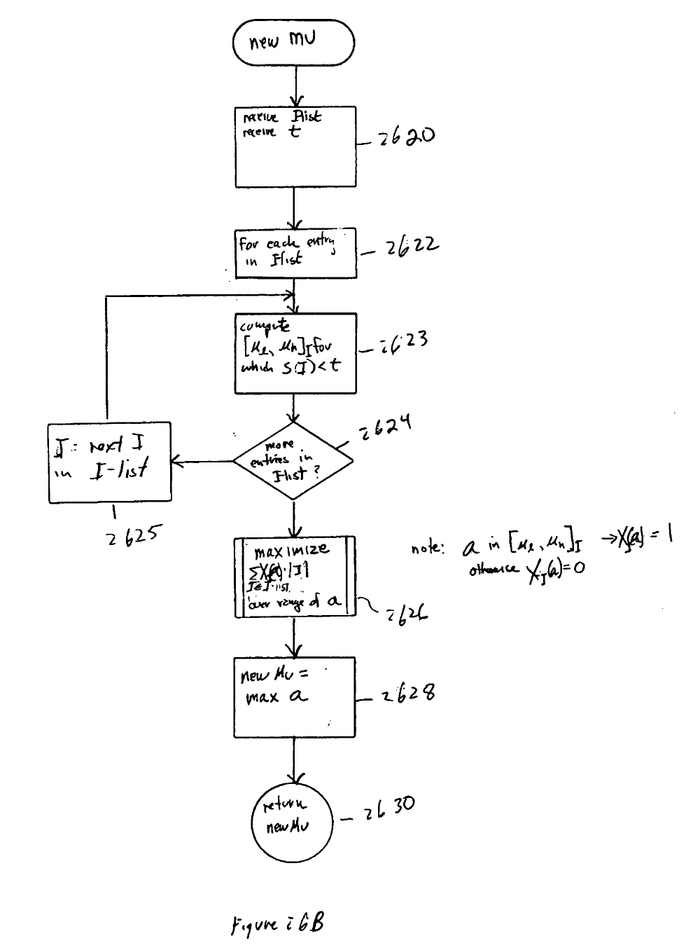

FIG. 23 shows a plot of the number of normal-copy-number chromosome subsequences versus the zero-point value used in aberration-calling analysis, similar to the plot shown in FIG. 20. In this case, the sharp, pronounced peak 2302 occurs at a ζ value of 1.2. FIGS. 24A-C show amplification/deletion plots generated by the aberration-calling method using a zero-point value, or centralization constant ζ, of 1.2, as suggested by the ζ value of the S(I) peak observed in the plot shown in FIG. 23. As can be readily observed by comparing FIGS. 24A-C to FIGS. 17A-C, use of the zero-point value 1.2 results in recovery of the resolution and apparent accuracy previously observed for the original data set shown in FIGS. 14A-C when analyzed by aberration-calling analysis using the zero-point value 0.0. In other words, the Occam's-Razor-like method of various embodiments of the present invention effectively compensates for the overall ploidity increase in order to reveal amplified and deleted regions despite an overall three-fold amplification of the genome from which the red signal is extracted. In addition, the selected zero-point value, in the discussed hypothetical example, is indicative of the ploidity increase, with a value close to ln(3).

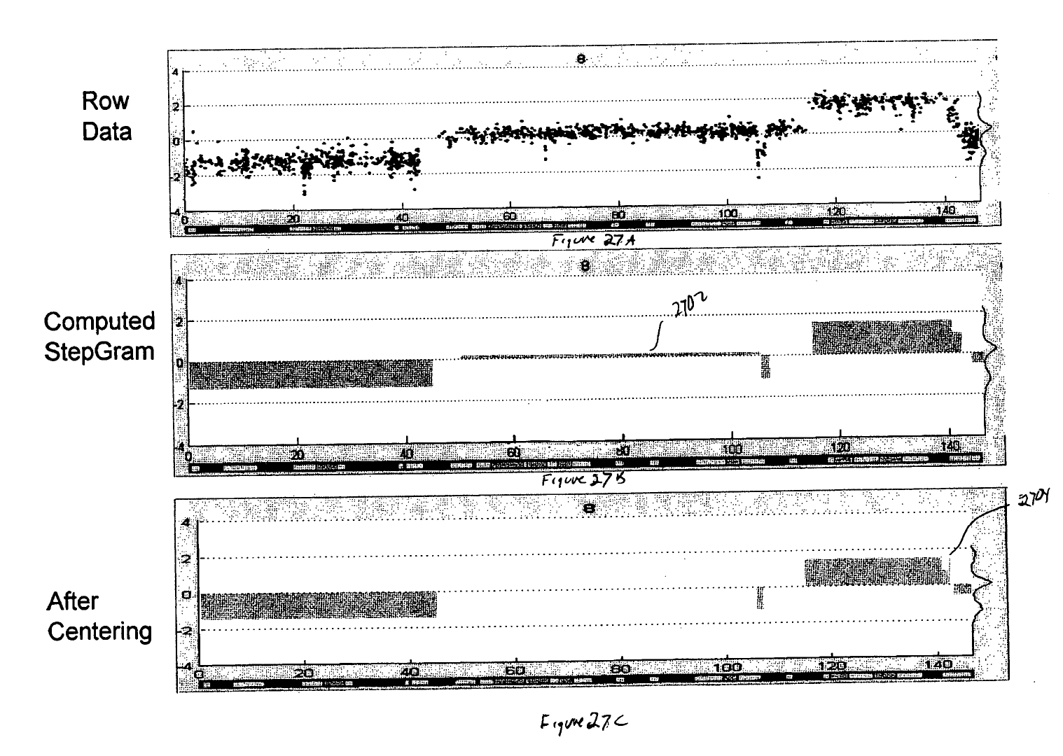

FIG. 25 illustrates, as a control-flow diagram, one method embodiment of the present invention. FIG. 25 diagrams a routine “center,” which computes a zero-point value, or centralization constant ζ, for a red/green aCGH data set using the Occam's-Razor-like strategy discussed above with reference to FIGS. 20 and 23. In step 2502, the routine “center” receives red/green data for a number of chromosomes and the threshold value t. Next, in step 2504, the routine “center” sets local variables maxNorm and maxMu to 0. In the for-loop of 2506-2510, the routine “center” repeatedly carries out an aberration-calling method, in one embodiment an aberration-calling analysis of the received aCGH data set, in each iteration using a different ζ value from a range of ζ values over which the for-loop iterates. Although a fixed range of ζ values is used in the described method, in alternative methods, a ζ-value range may be selected based on control-feature analysis, additional experimental results, or other additional information. When the number of normal-copy-number chromosome subsequences returned by a current call to the aberration-calling method exceeds the value stored in the variable maxNorm, as determined in step 2508, maxNorm is set to the number of normal-copy-number chromosome subsequences returned by the current call to the aberration-calling method, and the variable maxMu is set to the current ζ value employed by the routine “step-gram function.” If there are more ζ's within the range of ζ's over which the number of normal-copy-number subsequences is to be computed, as determined in step 2510, the for-loop iterates again. Otherwise, the value stored in the variable maxMu is returned as the zero-point value for the received aCGH data set, in step 2512.

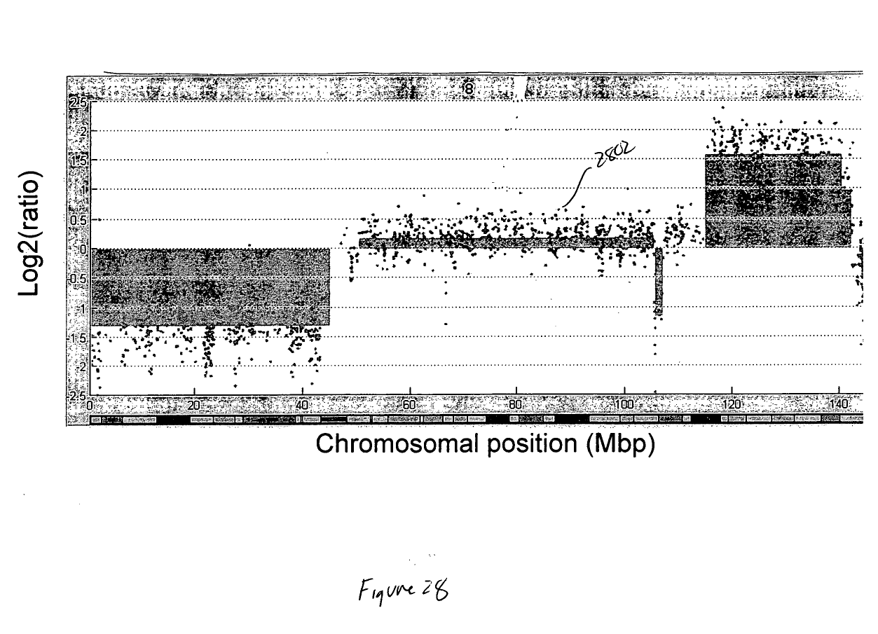

A second embodiment of the present invention employs a heuristic approach to more rapidly converge on a zero-point value. FIGS. 26A-B illustrate, as two control-flow diagrams, an alternative routine “center” representing a second method embodiment of the present invention for finding the zero-point value, or centralization constant ζ, for an aCGH data set. In step 2602, the alternative routine “center” receives a red/green aCGH data set as well as a threshold value t. In step 2604, the alternative routine “center” sets the local variable mu to 0. Different, initial mu values may be used, in alternative embodiments, based on control-feature analysis, additional experimental results, or based on other considerations. In step 2606, the alternative routine “center” calls an aberration-calling method to carry out analysis of the received aCGH data set, in one embodiment an interval-based method. In step 2608, the alternative routine “center” sets the local variable numNorm to the value returned by the routine “step-gram function,” the number of normal-copy-number chromosome subsequences. Next, in the while-loop of steps 2610 through 2614, the alternative routine “center” iteratively computes a new ζ value, and then carries out the aberration-calling method using the new ζ value, until the number of normal-copy-number chromosome subsequences determined by aberration-calling method does not increase. The ζ value prior to the ζ value for which the number of normal-copy-number chromosome subsequences does not increase is returned, in step 2616, as the zero-point value, or the centralization constant ζ, for the received aCGH data set.

FIG. 26B shows, as a control-flow diagram, the routine “new Mu,” called as step 2611 in FIG. 26A. In step 2620, the routine “new Mu” receives an ordered list of intervals I-list computed by a call to an interval-based aberration-calling function and a threshold value t. Next, in the for-loop of steps 2622-2625, the routine “new Mu” computes, for each interval I in the list of intervals I-list, a range of ζ, values [ζₗ(I), ζₕ(I)] that, when used to compute an S(I) score of the interval, produce an S(I) score with magnitude less than or equal to the threshold value t. Then, in step 2626, the routine “new Mu” computes the maximum value of the expression:

$$f ( a ) = {\sum }_{I ∈ I - list} {X}_{I} ( a ) \cdot \vert I \vert$$

where X₁(a)=1 if a is in [ζₗ(I), ζₕ(I)] and 0 otherwise. In other words, the routine “new Mu” finds a value of a for which the maximum number of intervals in the list I-list would have normal-copy-number values. Next, in step 2628, the local variable newMu is set to the value a for which the expression

$$f ( a ) = {\sum }_{I ∈ I - list} {X}_{I} ( a ) \cdot \vert I \vert$$

has a maximum value. The value stored in newMu is returned, in step 2630, as the new ζ value.

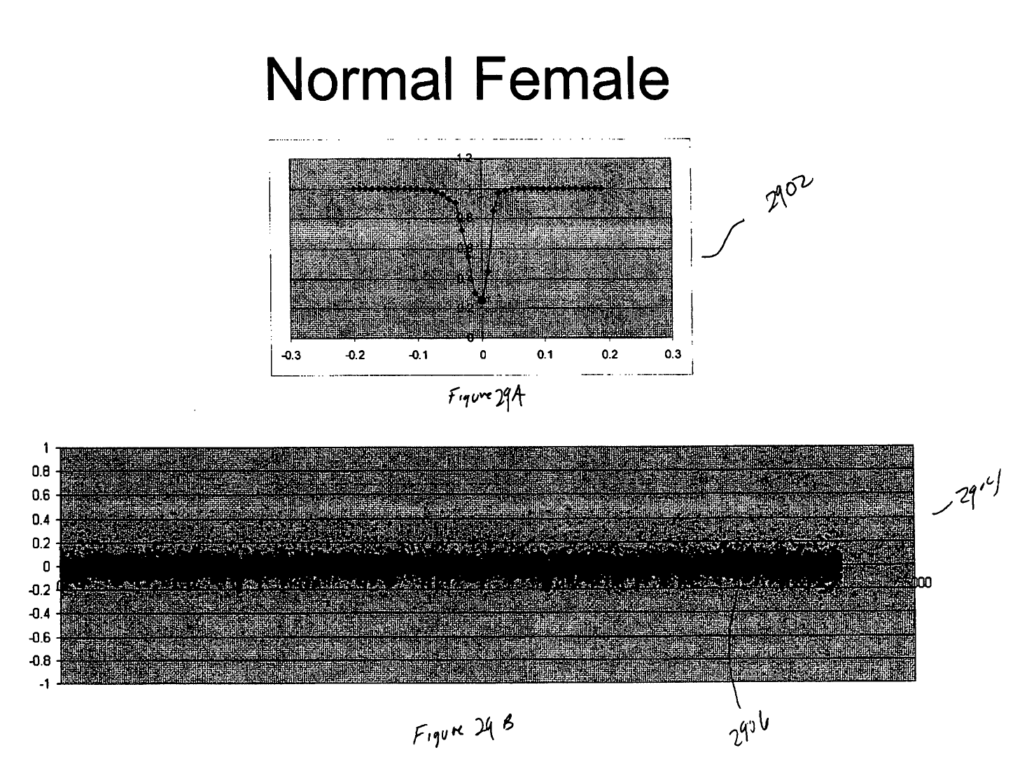

While the zero-point-determination methods of the present invention are described, above, using hypothetical data and the figures are generated using a simplified interval-based aberration-calling method, results using real aCGH data sets analyzed with a rigorous, interval-based aCGH analysis method are next provided. FIGS. 27A-C illustrate improvement in the determination of amplified and deleted regions using a zero-point value obtained by method embodiments of the present invention. FIG. 27A shows plotted log-ratio values for a portion of human chromosome 8. FIG. 27B shows indications of deleted and amplified regions within the portion of human chromosome 8. Note the relatively long, slightly amplified region 2702 occupying the center portion of the plotted amplified and deleted regions, in FIG. 27B. The amplified and deleted regions were computed using a zero-point value of 0. Next, a zero-point value is computed using a method embodiments of the present invention, and the amplified and deleted regions are recalculated using the computed zero-point value. As can be seen in FIG. 27C, the indication of a lengthy, slightly amplified region (2702 in FIG. 27B) no longer occurs. Note also the increased resolution of the indications of amplified and deleted regions. For example, a very short, amplified region 2304 is observed towards the right-hand extremity of the plot that is not visible in the plot shown in 27B, computed with a zero-point value of 0.0. FIG. 28 illustrates the same portion of the human chromosome 8 shown in FIGS. 27A-C, with the log-ratio data superimposed over indications of deleted and amplified regions computed using a zero-point value of 0.0. It can readily be observed, in FIG. 28, that a slight shift of the zero-point value upward, by 0.02, would distribute the log-ratio data within the central, slightly amplified region 2702 symmetrically about the shifted zero-point value, therefore removing the putative, slightly amplified region.

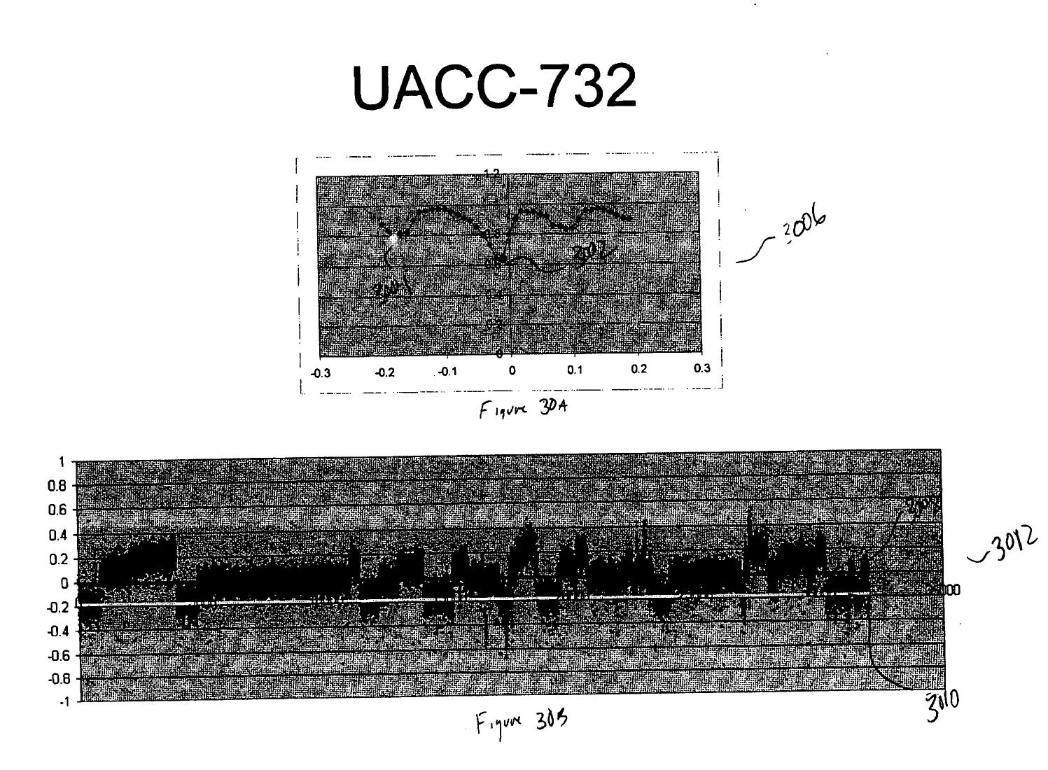

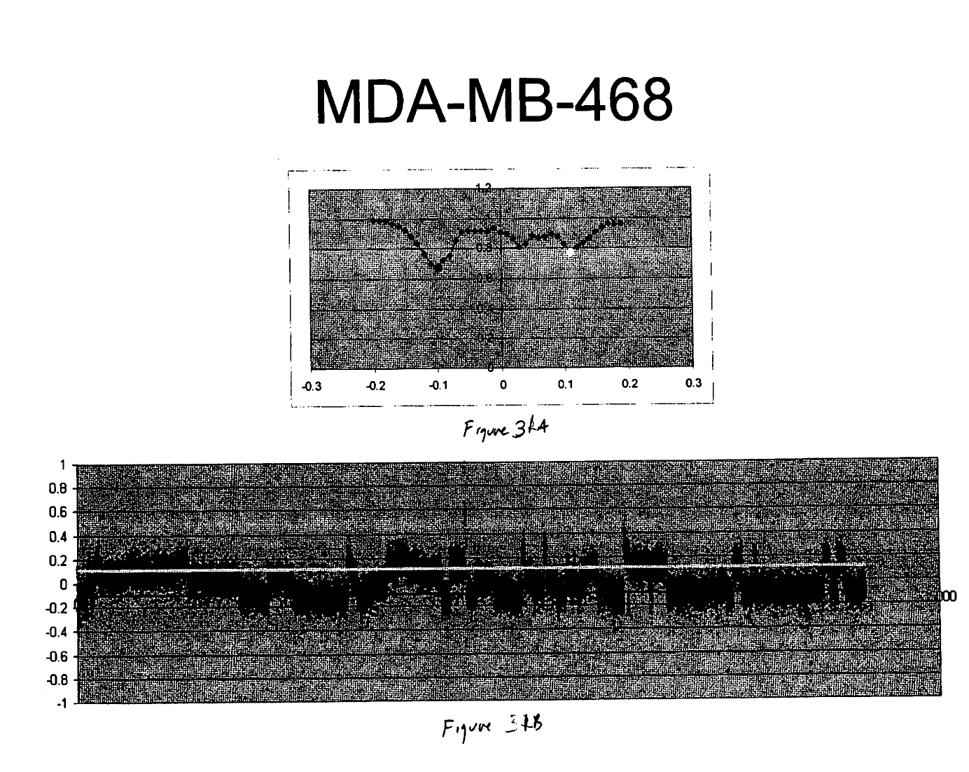

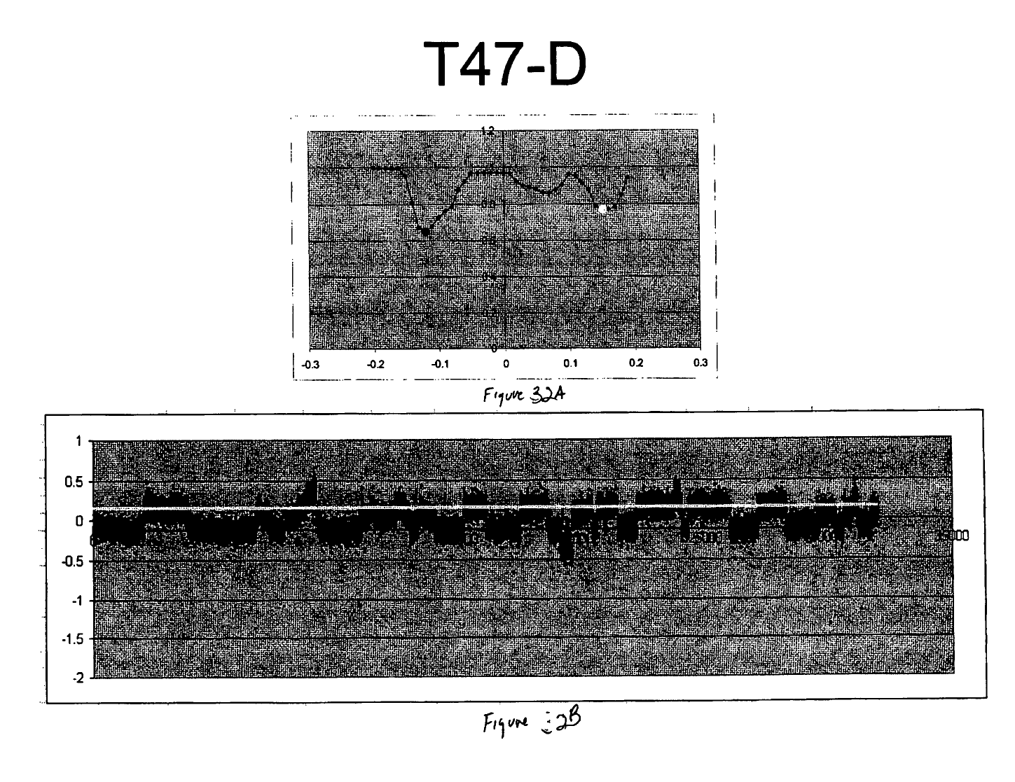

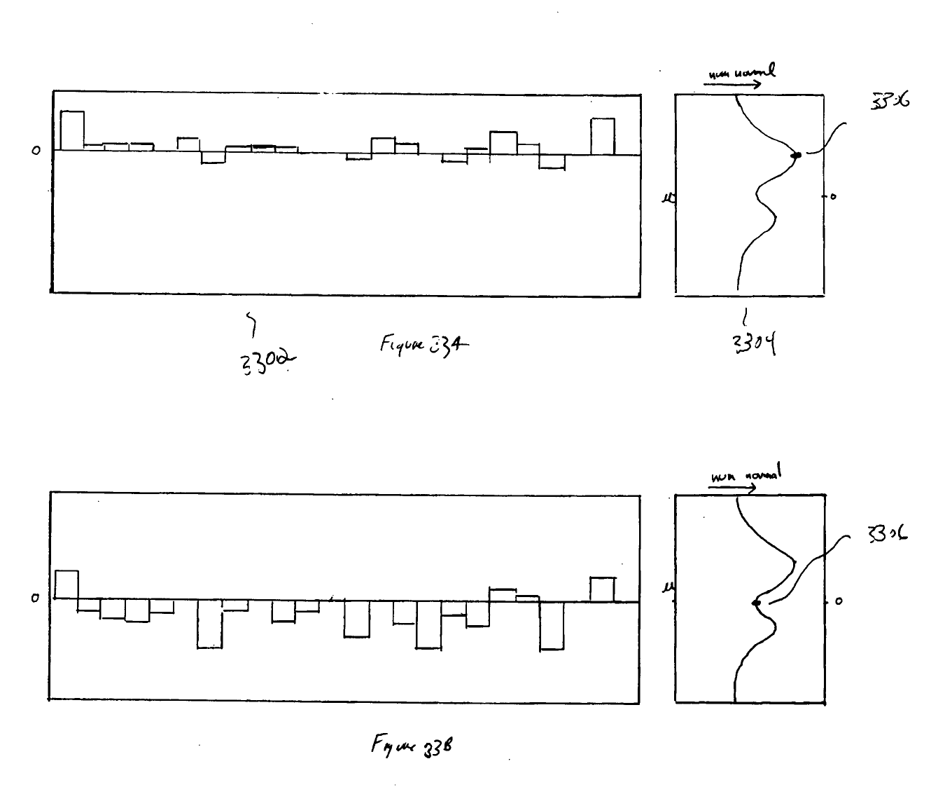

Next, plots of aCGH data for normal and pathological tissues are provided, along with plots of the number of abnormal-copy-number tissues determined by successive interval-based aCGH analyses using a range of zero-point values. FIGS. 29A-B show a plot of the number of abnormal-copy-number chromosome subsequences versus zero-point values used in successive interval-based aCGH analyses, along with a plot of the log-ratio data, over which a line indicating the best zero-point value is superimposed, for a normal tissue vs. a normal control. In the case of FIGS. 29A-B, the aCGH data set is obtained from two normal, human female tissue samples, and, not surprisingly, the best zero-point value, corresponding to the peak in the plot of abnormal-copy-number subsequences versus zero-point values, is 0.0. FIGS. 30A-B show a plot of the number of abnormal-copy-number chromosome subsequences versus zero-point values used in successive interval-based aCGH analyses, along with a plot of the log ratio data over which a line indicating the indicated zero-point value is superimposed, for a pathological tissue vs. a normal control. By contrast, in FIGS. 30A-B, two non-zero minima 3002 and 3004 are observed in the plot of the number of abnormal-copy-number chromosome subsequences versus ζ values used in the determination of the abnormal-copy-number chromosome subsequences 3006. Horizontal lines 3008 and 3010 are shown in the log ratio plot 3012 corresponding to the values of ζ 3002 and 3004, respectively, for which the number of abnormally computed genes is minimal. In this case, the negative computed zero-point value indicates increased ploidity of the pathological tissue. FIGS. 31A-B show additional plots of the number of abnormal-copy-number chromosome subsequences versus zero-point values used in interval-based aCGH analysis, along with a plot of the log ratio data over which a line indicating the indicated zero-point value is superimposed, for additional pathological tissues vs. normal controls, using the same illustration conventions as used in FIGS. 30A-B. Further examples of computed zero-point values from aCGH data sets extracted from normal and pathological tissues are shown in FIGS. 32A-B, using the same illustration conventions as used in FIGS. 30A-B. In all of the pathological-tissue-based aCGH data sets, the computed zero-point value is different from 0.0, indicating that the most accurate and highest resolution amplification and deletion plots are obtained by interval-based aCGH analyses techniques using zero-point values computed by method embodiments of the present invention, rather than a centralization constant of 0 or a centralization constant based on signal averaging methods over the entire data set.

FIGS. 33A-B show a user-interface display that represents one embodiment of the present invention. Many different user-interface displays are possible for showing the subsequence-copy information produced by an aberration-calling method, along with a representation of the dependence of the number of normal-copy-number subsequences in a sequence on the centralization constant ζ. In one embodiment, a graph of the relative copy numbers 3302 of a sample genome is shown, similar to the graphs shown in FIGS. 15A-19C, aligned with a graph 3304 of the number of normal-copy sequences with respect to the candidate centralization constant ζ, similar to the graphs shown in FIGS. 20 and 23. As a user selects new values for ζ, the graphs are updated to show the new aberration profiles based on the new values for ζ, and an indication 3306 of the currently selected value of ζ on the curve showing the dependence of the number of normal-copy subsequences on ζ. In alternative embodiments, the displayed ζ indication may be selectable and moveable, via the user-interface display, to a new position, with automatic recalculation of the aberration profile. Alternatively, a horizontal line representing the current zero-point value may be selectable and moveable, via the user-interface display, to a new position, with automatic recalculation of the aberration profile. Many additional user-interface displays featuring presentation of centralization constants, dependence of the number of normal-copy sequences on the centralization constant, and aberration profiles are possible. In general, the range, in subsequences, for the aberration profile is selectable, allowing a user to zoom into, and zoom out from, particular displayed ranges.

Although the present invention has been described in terms of particular embodiments, it is not intended that the invention be limited to this embodiment. Modifications within the spirit of the invention will be apparent to those skilled in the art. For example, the zero-point determination methods of the present invention may be applied to an aCGH data set using any type of interval-based aCGH analysis, in addition to the several types of interval-based aCGH analysis discussed above, as well as to any other aberration-calling method. Although two method embodiments of the present invention are discussed above, many additional embodiments are possible, using different minimization and maximization techniques, different heuristics for method convergence, and other such algorithmic variations. In addition, an essentially limitless number of embodiments can be obtained by implementing the method embodiments of the present invention using different programming languages, control structures, data structures, modularization, and other, common programming parameters. Method embodiments of the present invention may be encoded in firmware, software, or a combination of software and firmware and included in analytical instruments and data-analysis systems of various types. Although, in the discussed embodiments, a single zero-point value is computed, in alternative embodiments of the present invention, multiple zero-point values may be computed for genome subsets, in order to provide even greater resolution and accuracy. Any aberration-calling method can be used to compute a zero-point value by method embodiments of the present invention, including interval-based methods, described above, and other methods.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for determining a zero-point value for an aCGH data set for a sample and a control, the method comprising:
selecting an initial zero-point value;
selecting a range of putative zero-point values;
for each putative zero-point value
carrying out an aberration-calling aCGH analysis of the aCGH data set to determine a result for the putative zero-point value; and
selecting as the determined zero-point value the putative zero-point value that provided a most desirable result.

2. The method of claim 1 wherein the initial zero-point value and range of putative zero-point values are selected arbitrarily.

3. The method of claim 1 wherein the initial zero-point value and range of putative zero-point values are selected based on one of:
additional experimental results;
control-feature analysis; and
log-ratio normalization.

4. The method of claim 1 wherein carrying out aberration-calling aCGH analysis of the aCGH data set to determine a result for the putative zero-point value further includes determining a number of chromosomal subsequences that have normal copy numbers in the sample.

5. The method of claim 1 wherein carrying out aberration-calling aCGH analysis of the aCGH data set to determine a result for the putative zero-point value further includes determining a number of chromosomal subsequences that have abnormal copy numbers in the sample.

6. The method of claim 1 wherein carrying out aberration-calling aCGH analysis of the aCGH data set to determine a result for the putative zero-point value further includes determining a number of probes corresponding to probe-complementary chromosomal subsequences that have normal copy numbers in the sample.

7. The method of claim 1 wherein carrying out aberration-calling aCGH analysis of the aCGH data set to determine a result for the putative zero-point value further includes determining a number of probes corresponding to probe-complementary chromosomal subsequences that have abnormal copy numbers in the sample.

8. The method of claim 1 wherein carrying out aberration-calling aCGH analysis of the aCGH data set to determine a result for the putative zero-point value further includes determining a ratio of probes corresponding to probe-complementary chromosomal subsequences that have normal copy numbers in the sample to the total number of probes.

9. The method of claim 1 wherein carrying out aberration-calling aCGH analysis of the aCGH data set to determine a result for the putative zero-point value further includes determining a ratio of probes corresponding to probe-complementary chromosomal subsequences that have abnormal copy numbers in the sample to the total number of probes.

10. The method of claim 1 wherein carrying out aberration-calling aCGH analysis of the aCGH data set to determine a result for the putative zero-point value further includes determining a ratio of probes corresponding to probe-complementary chromosomal subsequences that have normal copy numbers in the sample to the total number of probes.

11. The method of claim 1 wherein carrying out aberration-calling aCGH analysis of the aCGH data set to determine a result for the putative zero-point value further includes determining a ratio of a sums of chromosomal subsequences that have abnormal copy numbers to a total number of measured chromosomal subsequences.

12. The method of claim 1 wherein carrying out aberration-calling aCGH analysis of the aCGH data set to determine a result for the putative zero-point value further includes determining a ratio of a sums of chromosomal subsequences that have normal copy numbers to a total number of measured chromosomal subsequences.

13. The method of claim 1 wherein carrying out aberration-calling aCGH analysis of the aCGH data set to determine a result for the putative zero-point value further includes invoking an interval-based aCGH aberration-calling method.

14. The method of claim 1 wherein selecting as the determined zero-point value the putative zero-point value that provides a most desirable result further includes selecting the putative zero-point value that, when used in the aberration-calling aCGH analysis of the aCGH data set, results in determination of a fewest number of probe-complementary chromosomal subsequences that have abnormal copy numbers in the sample.

15. The method of claim 1 wherein selecting as the determined zero-point value the putative zero-point value that provides a most desirable result further includes selecting the putative zero-point value that, when used in the aberration-calling aCGH analysis of the aCGH data set, results in determination of a smallest ratio of probe-complementary chromosomal subsequences that have abnormal copy numbers in the sample to the total number of probe complementary sequences.

16. The method of claim 1 wherein selecting as the determined zero-point value the putative zero-point value that provides a most desirable result further includes selecting the putative zero-point value that, when used in the aberration-calling aCGH analysis of the aCGH data set, results in determination of a largest ratio of probe-complementary chromosomal subsequences that have normal copy numbers in the sample to the total number of probe complementary sequences.

17. The method of claim 1 wherein selecting as the determined zero-point value the putative zero-point value that provides a most desirable result further includes selecting the putative zero-point value that, when used in the aberration-calling aCGH analysis of the aCGH data set, results in determination of a largest sum of the lengths of normal-copy-number chromosomal subsequences.

18. The method of claim 1 wherein selecting as the determined zero-point value the putative zero-point value that provides a most desirable result further includes selecting the putative zero-point value that, when used in the aberration-calling aCGH analysis of the aCGH data set, results in determination of a smallest sum of the lengths of chromosomal subsequences that have abnormal normal copy numbers.

19. The method of claim 1 wherein selecting as the determined zero-point value the putative zero-point value that provides a most desirable result further includes selecting the putative zero-point value that, when used in the aberration-calling aCGH analysis of the aCGH data set, minimizes a computed metric or computed value selected from among:
a sum of weighted lengths of genomic subsequences;
a sum of probe weights;
a largest sum of the lengths of normal-copy-number chromosomal subsequences;
a smallest sum of the lengths of chromosomal subsequences that have abnormal normal copy numbers;
a largest ratio of probe-complementary chromosomal subsequences that have normal copy numbers in the sample to the total number of probe complementary sequences;
a fewest number of probe-complementary chromosomal subsequences that have abnormal copy numbers in the sample; and
a smallest ratio of probe-complementary chromosomal subsequences that have abnormal copy numbers in the sample to the total number of probe complementary sequences.

20. The method of claim 1 encoded in computer instructions stored on a computer readable memory.

21. The method of claim 1 included in one or a combination of logic circuits, firmware, software within one of:
an array-processing instrument;
an array-analysis device; and
an array data processing system.

22. A method for determining a zero-point value for an aCGH data set for a sample and a control, the method comprising:
selecting an initial zero-point value;
carrying out aberration-calling aCGH analysis of the aCGH data set using the initial zero-point value; and
while further improvement in a currently considered best zero-point value can be made,
determining a range of zero-point values for each probe-complementary subsequence that, when used in aberration-calling analysis, results in a determination that the subsequence has a normal copy number in the sample; and
identifying the currently considered best-zero-point value as the zero-point value for which the greatest number of probe-complementary sequences are found to have normal copy numbers in the sample.

23. The method of claim 22 wherein the initial zero-point value and range of putative zero-point values are selected arbitrarily.

24. The method of claim 22 wherein the initial zero-point value and range of putative zero-point values are selected based on one of:
additional experimental results;
control-feature analysis; and
log-ratio normalization.

25. The method of claim 22 encoded in computer instructions stored on a computer readable memory.

26. The method of claim 22 included in one or a combination of logic circuits, firmware, software within one of:
an array-processing instrument;
an array-analysis device; and
an array data processing system.

27. A user interface for displaying subsequence copy-number aberration profiles generated by aberration-calling methods that employ a centralization constant, the user interface comprising:
a graphical display of an aberration profile for a chromosome or genome sequence, the graphical display including an indication of the centralization constant value used in generating the aberration profile; and
a graphical display of the dependence of a computed value on the centralization constant.

28. The user interface of claim 27 wherein the computed value is one of:
a sum of weighted lengths of genomic subsequences;
a sum of probe weights;
a sum of the lengths of normal-copy-number chromosomal subsequences;
a sum of the lengths of chromosomal subsequences that have abnormal normal copy numbers;
a ratio of probe-complementary chromosomal subsequences that have normal copy numbers in the sample to the total number of probe complementary sequences;
a number of probe-complementary chromosomal subsequences that have abnormal copy numbers in the sample; and
a ratio of probe-complementary chromosomal subsequences that have abnormal copy numbers in the sample to the total number of probe complementary sequences.

29. The user interface of claim 27 wherein the size, in subsequences, of the displayed aberration profile is selectable and wherein an indication of the current centralization constant is displayed on the graphical display of the dependence of the number of normal-copy subsequences within the sequence on the centralization constant.

30. The user interface of claim 27 wherein parameters of the aberration-calling methods may be input by a user into parameter input components of the user interface.
